(19) United States
(12) Patent Application Publication
(10) Pub. No.: US 2023/0196632 A1
(43) Pub. Date: Jun. 22, 2023

(54) INFORMATION PROCESSING DEVICE AND INFORMATION PROCESSING METHOD

(71) Applicant: SONY GROUP CORPORATION, TOKYO (JP)

(72) Inventor: KAZUKO YAMADA, TOKYO (JP)

(21) Appl. No.: 17/998,654

(22) PCT Filed: May 12, 2021
(86) PCT No.: PCT/JP2021/017985

§ 371 Date: Nov. 12, 2022

(30) Foreign Application Priority Data
May 26, 2020 (JP) 2020-091281

(51) Int. Cl. G06T 11/00; H04S 7/00

(52) U.S. Cl. CPC G06T 11/00; H04S 7/302; H04S 2400/11

(57) ABSTRACT

The present technology relates to an information processing device and an information processing method which are capable of appropriate control of lectures and the like that are held with participants in a plurality of spaces. According to the present technology, received are an operation for displaying an overhead view image of a second space different from a first space in which the information processing device is disposed on a display unit disposed in the first space; an operation for displaying a list of a plurality of images of the second space to be captured at a plurality of captured positions on a display unit disposed in the first space; an operation for displaying an image in the first space on a display unit disposed in the second space; an operation for outputting a sound in the second space from a sound output unit disposed in the first space; and an operation for outputting a sound input from a sound input unit disposed in the first space from a sound output unit disposed in the second space. The present technology can be applied to a lecture/meeting system.

### TECHNICAL FIELD

The present technology relates to an information processing device and an information processing method, and more particularly, to an information processing device and an information processing method which are capable of appropriate control of lectures, meetings, and the like that are held with participants in a plurality of spaces.

### BACKGROUND ART

PTL 1 discloses a system in which a lecturer and students exchange information with each other when a lecture given by the lecturer is delivered to the students via the Internet in the field of e-learning and the like.

### CITATION LIST

### Patent Literature

### [PTL 1]

JP 2014-153688A

### SUMMARY

### Technical Problem

There is a need for appropriate control of lectures, meetings, and the like when the lectures, meetings, and the like are held with participants in a plurality of spaces.

The present technology has been made in view of such circumstances, and is capable of appropriate control of lectures, meetings, and the like held with participants in a plurality of spaces.

### Solution to Problem

An information processing device which is a first aspect of the present technology is an information processing device including an input unit that receives an operation for displaying an overhead view image of a second space different from a first space in which the information processing device is disposed on a display unit disposed in the first space; an operation for displaying a list of a plurality of images of the second space to be captured at a plurality of captured positions on a display unit disposed in the first space; an operation for displaying an image in the first space on a display unit disposed in the second space; an operation for outputting a sound in the second space from a sound output unit disposed in the first space; and an operation for outputting a sound input from a sound input unit disposed in the first space from a sound output unit disposed in the second space.

An information processing method which is a first aspect of the present technology is an information processing method including receiving, by an input unit included in an information processing device, an operation for displaying an overhead view image of a second space different from a first space in which the information processing device is disposed on a display unit disposed in the first space; an operation for displaying a list of a plurality of images of the second space to be captured at a plurality of captured positions on a display unit disposed in the first space; an operation for displaying an image in the first space on a display unit disposed in the second space; an operation for outputting a sound in the second space from a sound output unit disposed in the first space; and an operation for outputting a sound input from a sound input unit disposed in the first space from a sound output unit disposed in the second space.

According to a first aspect of the present technology, received are an operation for displaying an overhead view image of a second space different from a first space in which the information processing device is disposed on a display unit disposed in the first space; an operation for displaying a list of a plurality of images of the second space to be captured at a plurality of captured positions on a display unit disposed in the first space; an operation for displaying an image in the first space on a display unit disposed in the second space; an operation for outputting a sound in the second space from a sound output unit disposed in the first space; and an operation for outputting a sound input from a sound input unit disposed in the first space from a sound output unit disposed in the second space.

An information processing device which is a second aspect of the present technology is an information processing device including a display unit that is disposed in a second space different from a first space in which a specific person is present, the display unit displaying a space map that represents a virtual position of the specific person in the second space when the specific person virtually travels in the second space.

According to a second aspect of the present technology, in a second space different from a first space in which a specific person is present, a space map is displayed that represents a virtual position of the specific person in the second space when the specific person virtually travels in the second space.

### BRIEF DESCRIPTION OF DRAWINGS

FIG. 1 is a diagram illustrating an outline of the overall configuration of a lecture/meeting system to which the present technology is applied.

FIG. 2 is a diagram illustrating an example of the basic configuration of an information processing system.

FIG. 3 is a diagram illustrating an example of the configuration of an information processing device.

FIG. 4 is a diagram illustrating a topology of connection between information processing devices P and a cloud service 12.

FIG. 5 is a functional block diagram illustrating an example of the configuration of an information processing device.

FIG. 6 is a functional block diagram illustrating an example of the configuration of the cloud service 12.

FIG. 7 illustrates examples of scenarios (use forms) using the lecture/meeting system of FIGS. 1 and 4.

FIG. 8 is a diagram illustrating an example of the configuration of an information processing system 11A in Scenario 5.

FIG. 9 is a diagram illustrating an example of the configuration of an information processing system 11B in Scenario 5.

FIG. 10 is a diagram illustrating an example of an operation screen displayed on a display of each information processing device.

FIG. 11 is a diagram illustrating an example of an initial setting menu screen.

FIG. 12 is a sequence diagram illustrating an example of a flow of processing to connect devices in an initial setting for the lecture/meeting system.

FIG. 13 is a sequence diagram illustrating an example of a flow of operation device registration processing in an initial setting for the lecture/meeting system.

FIG. 14 illustrates an example of an image displayed on a display in a space in which students are present in a lecture view mode.

FIG. 15 illustrates an example of an image displayed on a display in a space in which a teacher is present in the lecture view mode.

FIG. 16 is a sequence diagram illustrating an example of a flow of lecture view processing in the lecture/meeting system.

FIG. 17 illustrates an example of an image displayed on a display in a space in which a teacher is present in an overhead view mode.

FIG. 18 is a sequence diagram illustrating an example of a flow of overhead view processing in the lecture/meeting system.

FIG. 19 illustrates an example of images displayed on a display of an information processing device for teacher in a group view mode.

FIG. 20 is a sequence diagram illustrating an example of a flow of group view processing in the lecture/meeting system.

FIG. 21 illustrates an example of an image displayed on a display of an information processing device for teacher in a group conversation mode.

FIG. 22 illustrates an example of icons displayed on a display for a conversation party group in the group conversation mode.

FIG. 23 is a sequence diagram illustrating an example of a flow of group conversation processing in the lecture/meeting system.

FIG. 24 illustrates an example of images displayed on a display of an information processing device for teacher in a space travel mode.

FIG. 25 illustrates an example of a space map in an initial state.

FIG. 26 illustrates an example of an image displayed on a display of each information processing device for group in a space travel mode.

FIG. 27 illustrates a rendering example of a space map 241 when a teacher is virtually moving in a space.

FIG. 28 illustrates a rendering example of the space map when a group conversation is started in the space travel mode.

FIG. 29 is a sequence diagram illustrating an example of a flow of space travel processing in the lecture/meeting system.

FIG. 30 is a sequence diagram illustrating an example of a flow of processing of footsteps and others in the space travel mode in the lecture/meeting system.

FIG. 31 illustrates an example of an image displayed on a display of an information processing device for the group which calls the teacher in the space travel mode.

FIG. 32 illustrates an example of an image displayed on a display of an information processing device for teacher in the space travel mode.

FIG. 33 is a block diagram illustrating an example of a hardware configuration of a computer that executes a series of processing according to a program.

### DESCRIPTION OF EMBODIMENTS

Hereinafter, embodiments of the present technology will be described with reference to the drawings.

<<Lecture/Meeting System 1 to which the Present Technology is Applied>>

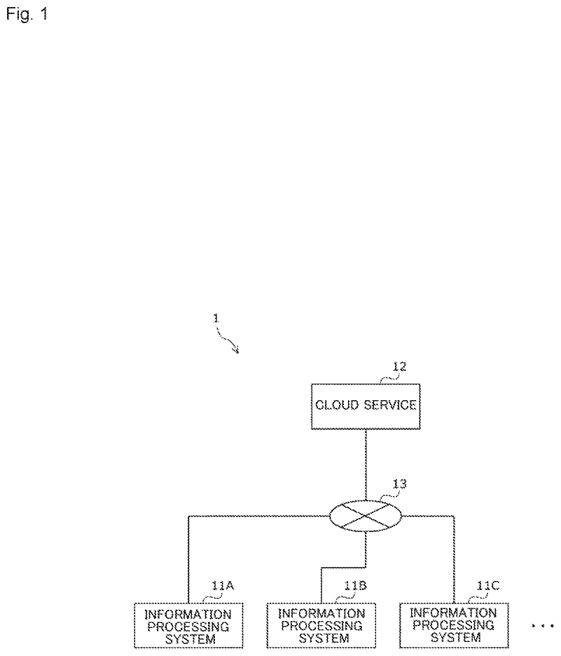

FIG. 1 is a diagram illustrating an outline of the overall configuration of a lecture/meeting system to which the present technology is applied.

In FIG. 1, the lecture/meeting system 1 includes one or more information processing systems 11 (11A, 11B, 11C, . . . ) and a cloud service 12.

(Information Processing System 11)

An information processing system 11 is deployed for each space such as each of a plurality of mutually isolated classrooms and meeting rooms. The number of information processing systems 11, that is, the number of spaces in which the information processing systems 11 are deployed, is not limited to a specific number, and depends on the number of places (spaces) that allows for participation in lectures and meetings. For example, in a case where a student takes a lecture in a space B (second space) that is remote from a space A (first space) in which a teacher gives a lecture, the information processing system 11 is deployed in each of the space A and the space B. As used herein, alphabets A, B, C, . . . are symbols for identifying the spaces. In order to identify the information processing system 11 deployed in a certain space, the symbol for the space is attached to the end of symbol 11.

The information processing system 11 includes one or more information processing devices (described later) by each of which a participant who participates in a lecture or a meeting exchanges various types of information with other participants, and the like.

The respective information processing systems 11 are communicably connected to a network 13 such as the Internet. Each information processing system 11 exchanges various types of information with other information processing systems 11 and the cloud service 12 via the network 13.

(Cloud Service 12)

The cloud service 12 is communicably connected to the network 13 and exchanges various types of information with the information processing systems 11 via the network 13.

The cloud service 12 executes predetermined program processing and manages connections between the information processing systems 11, and the like. The cloud service 12 may be a server computer that executes a predetermined program through the network 13.

(Configuration of Information Processing System 11)

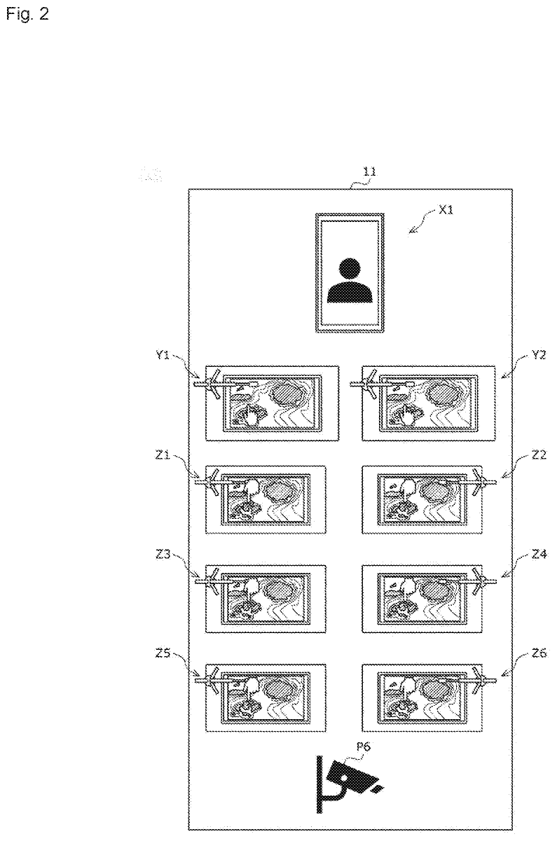

FIG. 2 is a diagram illustrating an example of the basic configuration of the information processing system 11.

The information processing system 11 in FIG. 2 includes information processing devices X1, Y1, Y2, Z1 to Z6 which are disposed in one space.

Each of the information processing devices X1, Y1, Y2, and Z1 to Z6 is composed of a personal computer (PC) and devices connected to the PC. In FIG. 2, each information processing device is illustrated as a schematic diagram of a display.

The information processing devices X1, Y1, Y2, and Z1 to Z6 are referred to with different alphabets (X, Y, Z) included in their symbols depending on their use. The number following the alphabet included in each symbol indicates a consecutive number assigned to information processing devices for the same purpose. Some information processing devices among the information processing devices for the same purpose are each represented by only an alphabetic symbol (information processing devices X, Y, and Z).

(Information Processing Device X)

The information processing device X is a general information processing device that is available for all participants. The information processing device X includes a large display that can be viewed by almost all the participants in the space in which the information processing system 11 is deployed. The information processing device X mainly displays, on the display, images to be provided to all the participants which are mostly present in the space. The display is disposed, for example, near the front wall of the space in which the information processing system 11 is deployed. However, the position and orientation of the display are not limited to a specific position and orientation in the space as long as the position and orientation are easy for the participants in the space to view.

The information processing device X includes a composite sensor P6 including a video camera that captures an overhead view image in which substantially the entire space in which the information processing system 11 is deployed appears. The composite sensor P6 of the information processing device X1 is installed, for example, at a high position such as a ceiling near the rear wall of the space in which the information processing system 11 is deployed.

Although only one information processing device X1 is illustrated in FIG. 2, a plurality of information processing devices X may be disposed.

(Information Processing Device Y)

The information processing device Y is an information processing device that is available for a teacher (lecturer, professor, etc.) or a facilitator such as a person who proceeds with a lecture or a meeting.

Although two information processing devices Y1 and Y2 are illustrated in FIG. 2, one, three, or more information processing devices Y may be disposed depending on the number of facilitators. The information processing device Y may not be provided in a space or the like where there is no facilitator.

(Information Processing Device Z)

The information processing device Z is an information processing device that is available for a participant (excluding a facilitator) such as a student and a meeting participant.

Although six information processing devices Z1 to Z6 are illustrated in FIG. 2, one or more (excluding six) information processing devices Z may be disposed depending on the number of participants (excluding the facilitator). One information processing device Z may be shared by one or more participants (excluding the facilitator). The information processing device Z may not be provided in a space in which there is no participant other than the facilitator.

(Configuration of Information Processing Device)

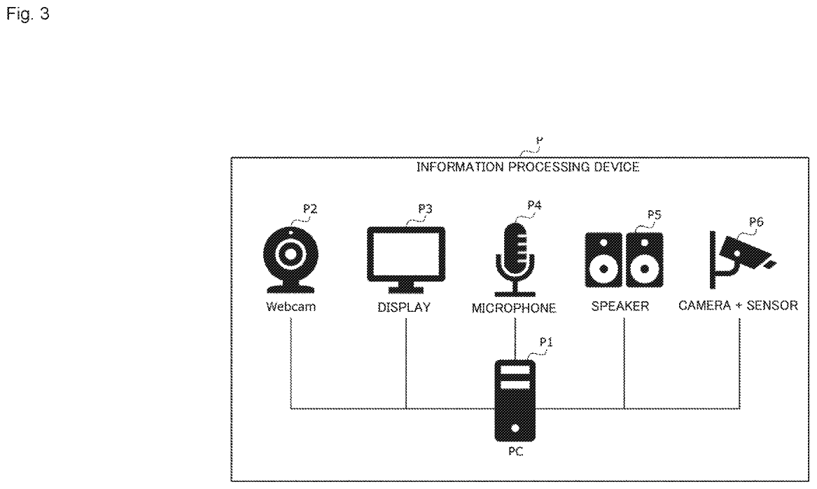

FIG. 3 is a diagram illustrating an example of the configuration of the information processing device of FIG. 2. When the information processing devices X, Y, and Z are not distinguished, an information processing device P is referred to as any one of the information processing devices.

The information processing device P includes a PC main body P1, a web camera P2, a display (display unit) P3, a microphone P4, a speaker P5, and a composite sensor P6.

The PC main body P1 executes predetermined application programs to perform various types of processing.

The web camera P2 mainly captures the periphery of a person who is viewing the display P3, and supplies the captured image to the PC main body P1.

The display P3 displays the image supplied from the PC main body P1. The display P3 is a display with a touch panel that detects a touch operation on a screen. The display P3 detects an input operation by a user touching the screen and supplies the input operation to the PC main body P1. The information processing device P may include an input device such as a mouse or a keyboard.

The microphone P4 converts a sound (or including voice) from people around the microphone P4 into an electrical signal and supplies the electrical signal to the PC main body P1 as an acoustic signal.

The speaker P5 converts the acoustic signal supplied from the PC main body P1 into sound and outputs the sound.

The composite sensor P6 integrally includes various types of sensors such as a video camera, a depth sensor, a spatial microphone array, and an orientation sensor. The composite sensor P6 supplies information acquired by such sensors to the PC main body P1.

The composite sensor P6 included in the information processing device X is used, for example, to acquire an overhead view image of the entire space and to detect the position of a person. The composite sensor P6 included in the information processing device Y and the information processing device Z is used, for example, to acquire an image of the hand from above and to detect hand movement.

(Configuration Example of Each Information Processing Device and Cloud Service)

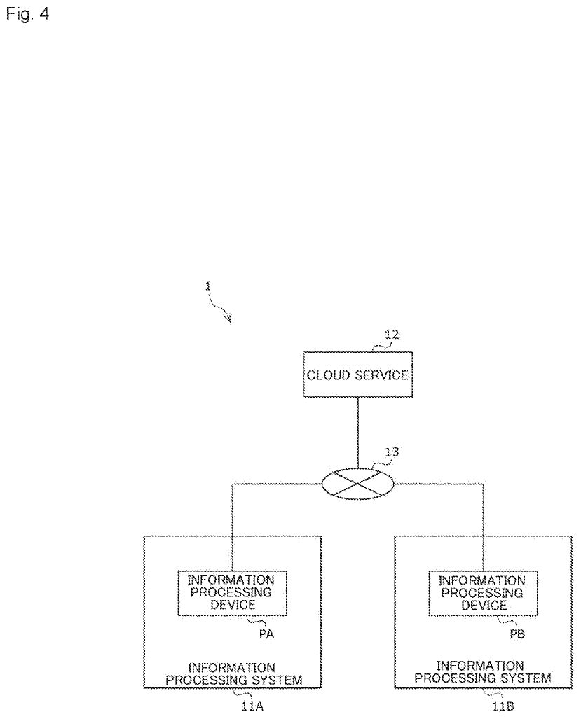

FIG. 4 is a diagram illustrating a topology of connection between information processing devices P and the cloud service 12.

FIG. 4 illustrates as an example a case where information processing systems 11A and 11B are deployed in two spaces A and B, respectively. An information processing device PA in the information processing system 11A corresponding to any one of the information processing device P, that is, any one of the information processing devices X, Y, and Z included in the information processing system 11A (disposed in the space A). An information processing device PB in the information processing system 11B corresponding to any one of the information processing device P, that is, any one of the information processing devices X, Y, and Z included in the information processing system 11B (disposed in the space B).

The information processing device PA, the information processing device PB, and the cloud service 12 are communicably connected to the network 13. The network 13 is composed of, for example, individual networks (local networks) for the information processing systems 11A and 11B to which the information processing devices PA and PB are connected, respectively, and a network such as the Internet connecting the local networks via their gateways (routers and the like). Note that the configuration of the network 13 may be of any form.

The information processing device PA, the information processing device PB, and the cloud service 12 exchange various types of information with each other via the network 13.

(Configuration of Information Processing Device P)

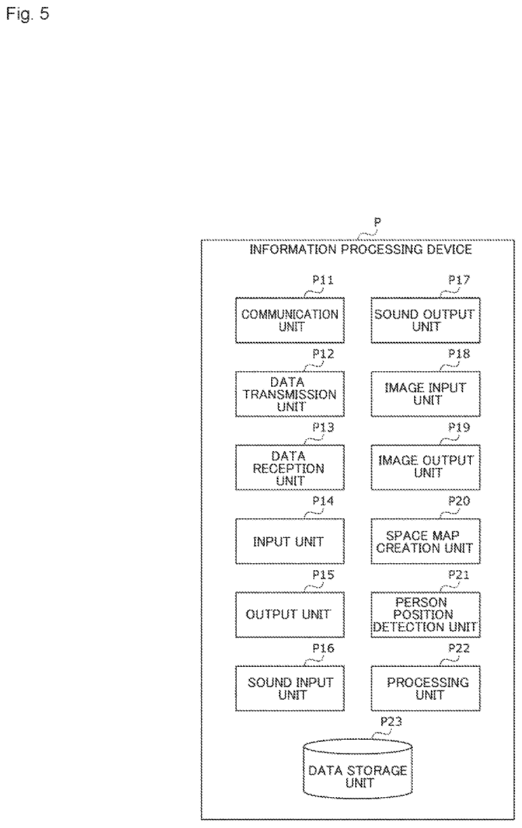

FIG. 5 is a functional block diagram illustrating an example of the configuration of the information processing device P.

The information processing device P includes a communication unit P11, a data transmission unit P12, a data reception unit P13, an input unit P14, an output unit P15, a sound input unit P16, a sound output unit P17, an image input unit P18, an image output unit P19, a space map creation unit P20, a person position detection unit P21, a processing unit P22, and a data storage unit P23.

The communication unit P11 controls communication with other devices (any other information processing device P and the cloud service 12).

The data transmission unit P12 transmits an image (image signal), a sound (acoustic signal), a space map, and various other types of data to a destination device specified by the processing unit P22 via the communication unit P11. The image transmitted from the data transmission unit P12 is an image captured by the web camera P2 or the video camera of the composite sensor P6, which is included in the corresponding information processing device P, and is supplied from the image input unit P18. The sound transmitted from the data transmission unit P12 is a sound input from the microphone P4, which is included in the corresponding information processing device P, and is supplied from the sound input unit P16. The space map transmitted from the data transmitting unit P12 is a space map created by the space map creation unit P20, and is supplied from the space map creation unit P20. The space map is information graphically representing the arrangement of things, people, and others in the space in which the corresponding information processing device P is disposed (details will be described later). Various types of data other than the image, sound, and space map which are transmitted from the data transmission unit P12 are supplied from the processing unit P22.

The data reception unit P13 receives an image, a sound, a space map, and various other types of data transmitted from another device via the communication unit P11. The data reception unit P13 supplies the received image to the image output unit P19, supplies the received sound to the sound output unit 17, and supplies the received space map to the output unit P15. The data reception unit P13 supplies various received types of data other than the image, sound, and space map to the processing unit P22.

The input unit P14 includes a touch panel (input device). The input unit P14 receives a user operation on the touch panel and supplies the user operation to the processing unit P22. The input unit P14 may include a mouse and/or a keyboard as an input device other than the touch panel.

The output unit P15 includes the display P3 (output device). The output unit P15 supplies an operation screen, a space map, and the like to the display P3 and outputs them from the display P3 (causes the display P3 to display them).

The sound input unit P16 includes the microphone P4 (acoustic device). The sound input unit P16 converts a sound from the user or the like into an electrical signal (acoustic signal) using the microphone P4 and supplies the electrical signal (acoustic signal) to the data transmission unit P12.

The sound output unit P17 includes the speaker P5. The sound output unit P17 outputs the sound (acoustic signal) supplied from the data reception unit P13 or the sound (acoustic signal) supplied from the processing unit P22 to the corresponding space.

The image input unit P18 includes an imaging device. The imaging device is the web camera P2 or the video camera of the composite sensor P6. The image input unit P18 supplies the image (image signal) captured by the imaging device to the data transmission unit P12.

The image output unit P19 includes the display P3 (output device). The image output unit P19 supplies the image supplied from the data reception unit P13 to the display P3 and outputs the image from the display P3. The image output from the display P3 by the image output unit P19 and the operation screen and space map output from the display P3 by the output unit P15 are synthesized or switched by a display control unit (not illustrated), and output from the display P3.

The space map creation unit P20 detects, based on the overhead view image captured by the video camera of the composite sensor P6 and the analysis result supplied from the person position detection unit P21, the arrangement of people and things in the space in which the corresponding information processing device P is disposed. The space map creation unit P20 creates from the detected arrangement of people and things a space map of the space in which the corresponding information processing device P is disposed. The space map creation unit P20 supplies the created space map to the data transmission unit P12. The space map creation unit P20 may be not included in all the information processing devices P.

The person position detection unit P21 analyzes various types of sensing data from the composite sensor P6, and detects the place, hand movement, and the like of a person in the space in which the corresponding information processing device P is disposed. The person position detection unit P21 supplies the analysis result to the space map creation unit P20.

The processing unit P22 generally controls the processing executed by each of the components P11 to P23 of the corresponding information processing device P according to a user operation through the input unit P14. The processing unit P22 supplies data to be transmitted to another information processing device P to the data transmission unit P12.

The data storage unit P23 mainly includes a storage medium such as a hard disk drive built in the PC main body P1. The data storage unit P23 stores application programs executed by the CPU of the PC main body P1 to functionally construct each of the components P11 to P23, and various other types of data.

(Configuration of Cloud Service 12)

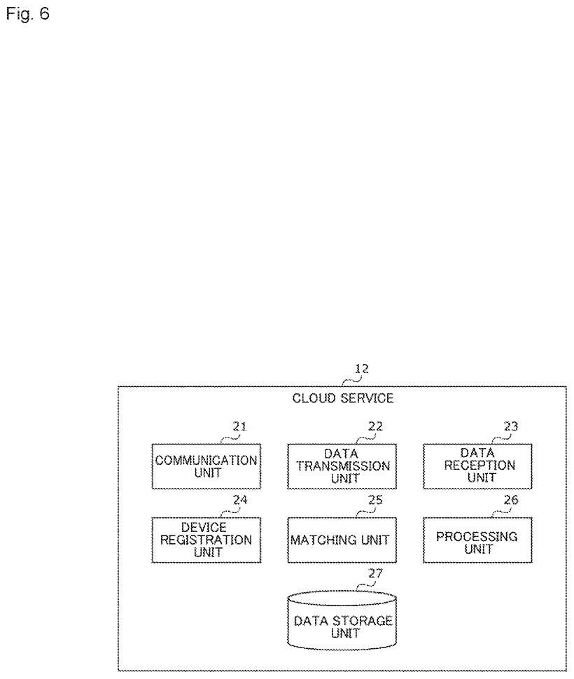

FIG. 6 is a functional block diagram illustrating an example of the configuration of the cloud service 12.

The cloud service 12 includes a communication unit 21, a data transmission unit 22, a data reception unit 23, a device registration unit 24, a matching unit 25, and a processing unit 26.

The communication unit 21 controls communication with the information processing devices PA and PB, each of which is any one of the information processing devices.

The data transmission unit 22 transmits, via the communication unit 21, a guide page for logging in to the cloud service 12 and various types of data to the information processing device PA or PB (see FIG. 4) that has accessed the cloud service 12. Data such as the guide page to be transmitted from the data transmission unit 22 is supplied from the processing unit 26.

The data reception unit 23 receives login data (user ID, etc.) and various other types of data transmitted from the information processing device PA or PB via the communication unit 21. The data reception unit 23 supplies the received data to the processing unit 26.

The device registration unit 24 stores, in a database, information on the information processing device PA or PB that has been logged in to the cloud service 12. The information on the information processing device PA or PB that has been logged in to the cloud service 12 is supplied from the processing unit 26 to the device registration unit 24.

The matching unit 25 retrieves suitable devices from the information processing devices PA and PB in response to a request from the available (online) information processing devices PA and PB that have been logged in to the cloud service 12, and performs the matching of them so that they can connect to each other.

The processing unit 26 generally controls the processing executed by each of the components 21 to 27 of the cloud service 12. The processing unit 26 supplies to the data transmission unit P12 a guide page for logging in to the cloud service 12 and data to be transmitted to the information processing devices PA and PB. The processing unit 26 authenticates whether or not to permit login to the cloud service 12 based on the login data from the data reception unit 23.

The data storage unit 27 mainly includes a storage medium such as a hard disk drive built in the cloud service 12. The data storage unit 27 stores application programs executed by the CPU of the cloud service 12 to functionally construct each of the components 21 to 27 and, various other types of data.

<Use Forms>

Next, use forms of the lecture/meeting system 1 illustrated in FIGS. 1 and 4 will be described.

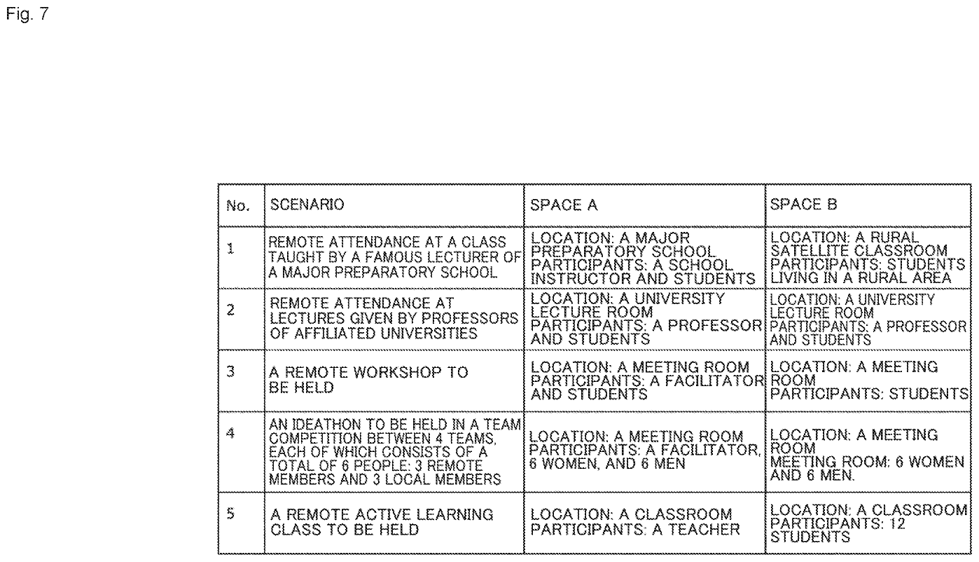

FIG. 7 illustrates examples of scenarios (use forms) using the lecture/meeting system 1 of FIGS. 1 and 4.

FIG. 7 illustrates five scenarios using the lecture/meeting system 1 as examples. In each of the scenarios, a case is described as an example in which a lecture, a meeting, or the like is held with participants in two spaces, space A and space B which is at a different location from space A (for example, a remote location).

Scenarios 1 and 2 are cases in which the lecture/meeting system 1 is used for lectures. Scenario 3 is a case in which the lecture/meeting system 1 is used for a workshop. Scenario 4 is a case in which the lecture/meeting system 1 is used for an ideathon. Scenario 5 is a case in which the lecture/meeting system 1 is used for an active learning class.

(Scenario 1)

Scenario 1 is for remote attendance at a class taught by a famous lecturer of a major preparatory school. The space A corresponds to a major preparatory school, and the participants in the space A correspond to preparatory a school instructor and students. The space B corresponds to a rural satellite classroom, and the participants in the space B correspond to students living in a rural area.

In the case of Scenario 1, the information processing systems 11A and 11B are deployed in the space A and the space B, respectively, as illustrated in FIG. 4. The information processing system 11A in the space A includes the general information processing device X, the information processing device Y for facilitator, which is available for a prep school teacher, and the information processing device Z for participant (excluding for facilitator), which is available for a student, which are illustrated in FIG. 2.

The information processing system 11B in the space B includes the general information processing device X, and the information processing device Z for participant (excluding for facilitator), which is available for a student, which are illustrated in FIG. 2. The information processing system 11B in the space B may not include the information processing device Y for facilitator.

(Scenario 2)

Scenario 2 is for remote attendance at lectures given by professors of affiliated universities. The space A corresponds to a university lecture room, and the participants in the space A correspond to a professor and students. The space B corresponds to a university lecture room, and the participants in the space B correspond to a professor and students.

In the case of Scenario 2, the information processing systems 11A and 11B are deployed in the space A and the space B, respectively, as illustrated in FIG. 4. The information processing system 11A in the space A includes the general information processing device X, the information processing device Y for facilitator, which is available for a professor of one affiliated university, and the information processing device Z for participant (excluding for facilitator), which is available for a student, which are illustrated in FIG. 2.

The information processing system 11B in the space B includes the general information processing device X, the information processing device Y for facilitator, which is available for a professor of the other affiliated university, and the information processing device Z for participant (excluding for facilitator), which is available for a student, which are illustrated in FIG. 2.

(Scenario 3)

Scenario 3 is for a remote workshop to be held. The space A corresponds to a meeting room, and the participants in the space A corresponds to a facilitator and students. The space B corresponds to a meeting room, and the participants in the space B correspond to students.

In the case of Scenario 3, the information processing systems 11A and 11B are deployed in the space A and the space B, respectively, as illustrated in FIG. 4. The information processing system 11A in the space A includes the general information processing device X, the information processing device Y for facilitator, which is available for a facilitator, and the information processing device Z for participant (excluding for facilitator), which is available for a student, which are illustrated in FIG. 2.

The information processing system 11B in the space B includes the general information processing device X, and the information processing device Z for participant (excluding for facilitator), which is available for a student, which are illustrated in FIG. 2. The information processing system 11B in the space B may not include the information processing device Y for facilitator.

(Scenario 4)

Scenario 4 is for an ideathon to be held in a team competition between four teams, each of which consists of a total of six people: three remote members and three local members. The space A corresponds to a meeting room, and the participants in the space A correspond to a facilitator, six women, and six men. The space B corresponds to a meeting room, and the participants in the space B correspond to six women and six men.

In the case of Scenario 4, the information processing systems 11A and 11B are deployed in the space A and the space B, respectively, as illustrated in FIG. 4. The information processing system 11A in the space A includes the general information processing device X, the information processing device Y for facilitator, which is available for a facilitator, and the information processing device Z for participant (excluding for facilitator), which is available for a team member, which are illustrated in FIG. 2.

The information processing system 11B in the space B includes the general information processing device X, and the information processing device Z for participant (excluding for facilitator), which is available for a team member, which are illustrated in FIG. 2. The information processing system 11B in the space B may not include the information processing device Y for facilitator.

(Scenario 5)

Scenario 5 is for a remote active learning class to be held. The space A corresponds to a classroom, and the participant in the space A correspond to a teacher. The space B corresponds to a classroom, and the participants in the space B are 12 students.

In the case of Scenario 5, the information processing systems 11A and 11B are deployed in the space A and the space B, respectively, as illustrated in FIG. 4. The information processing system 11A in the space A includes the general information processing device X and the information processing device Y for facilitator, which is available for a teacher, which are illustrated in FIG. 2. The information processing system 11A in the space A may not include the information processing device Z for participant (excluding for facilitator).

The information processing system 11B in the space B includes the general information processing device X, and the information processing device Z for participant (excluding for facilitator), which is available for a student, which are illustrated in FIG. 2. The information processing system 11B in the space B may not include the information processing device Y for facilitator.

<Example in Scenario 5>

A case will be described below as an example in which the lecture/meeting system 1 is used in Scenario 5 of Scenarios 1 to 5 described above.

In the case in which the lecture/meeting system 1 is used in Scenario 5, the lecture/meeting system 1 includes the information processing system 11A deployed in the space A which is a classroom in which a teacher is present, and the information processing system 11B deployed in the space B which is a classroom in which students are present. Accordingly, the overall configuration of the lecture/meeting system 1 is as illustrated in FIG. 4.

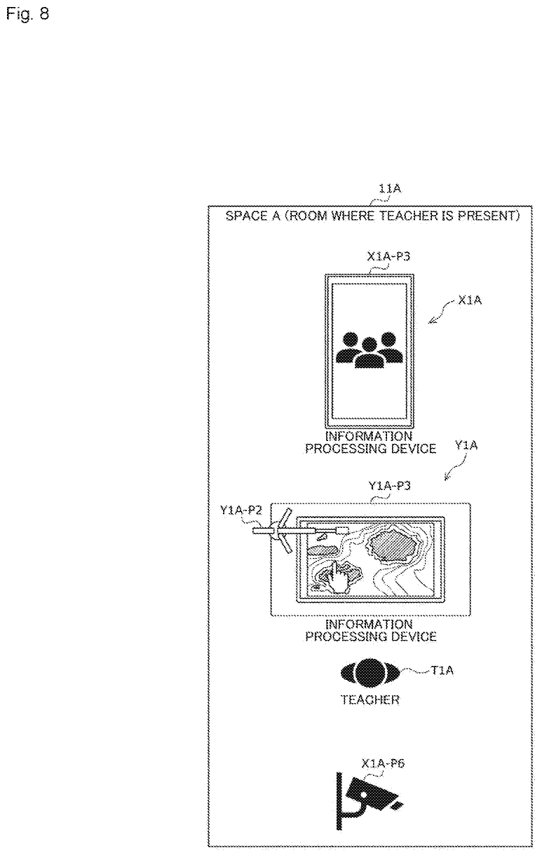

FIG. 8 is a diagram illustrating an example of the configuration of the information processing system 11A in Scenario 5.

In FIG. 8, the information processing system 11A is deployed in the space A in which a teacher T1A gives a class, and includes a general information processing device X1A and an information processing device Y1A for facilitator (hereinafter referred to as for teacher), which is available for the teacher T1A.

The general information processing device X1A includes the components P1 to P6 of the information processing device P illustrated in FIG. 3. Of the components P1 to P6, FIG. 8 illustrates a display X1A-P3 corresponding to the display P3 and a composite sensor X1A-P6 corresponding to the composite sensor P6.

The display X1A-P3 is disposed near the front wall of the space A, for example. The composite sensor X1A-P6 is installed, for example, at a high position such as a ceiling near the rear wall where a general view of the space A can be taken. The video camera of the composite sensor X1A-P6 captures an overhead view image of the space A. However, the composite sensor X1A-P6 does not have to be near the rear wall as long as it is at a position where a general view of the space A can be taken. The web camera P2 (not illustrated) of the information processing device X1A is set to capture the position of the teacher T1A from the front side of the teacher T1A.

The information processing device Y1A for teacher includes the components P1 to P5, which are other than the composite sensor P6 of the components P1 to P6 of the information processing device P illustrated in FIG. 3. Of the components P1 to P5, FIG. 8 illustrates a web cameras Y1A-P2 corresponding to the web camera P2 and a display Y1A-P3 corresponding to the display P3.

The web camera Y1A-P2 is installed, for example, on a desk in front of the teacher T1A seating. The web camera Y1A-P2 captures the face (upper body) of teacher T1A and the top of the desk.

The display Y1A-P3 is, for example, placed horizontally with its screen facing up on the desk in front of the teacher T1A seating. The schematic diagram of the display Y1A-P3 in FIG. 8 represents the desk used by the teacher T1A.

The composite sensor P6 (not illustrated) of the information processing device Y1A for teacher is installed, for example, on the upper part of the desk in front of the teacher T1A seating, and acquires an image of the hand of the teacher T1A and sensing data for detecting the movement of the hand of the teacher T1A.

Even in the case where the lecture/meeting system 1 is used in Scenario 5, the number of general information processing devices or the number of information processing devices for teacher in the space A is not limited to one, and a plurality of corresponding information processing devices may be disposed. One or more information processing devices for participant (for student) may be disposed.

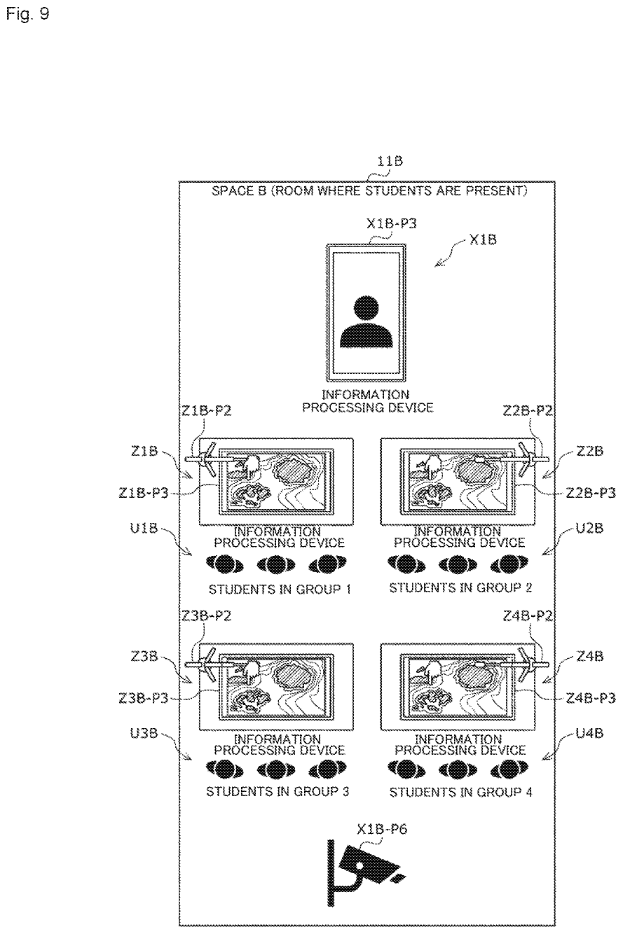

FIG. 9 is a diagram illustrating an example of the configuration of the information processing system 11B in Scenario 5.

In FIG. 9, the information processing system 11B is deployed in the space B in which students take a class, and includes a general information processing device X1B and information processing devices Z1B to Z4B for participant (hereinafter referred to as for student), which are available for students. There are 12 students in total in the space B, and the students are grouped into four groups 1 to 4, each of which consists of three students, for example. Students U1B to U4B in the groups 1 to 4 use the four information processing devices Z1B to Z4B for the respective groups. Note that one group may consist of any number of students other than three (including one student), and the information processing devices Z for student may be disposed as many as the number of groups. The number of people in each group may not be the same.

The general information processing device X1B includes the components P1 to P6 of the information processing device P illustrated in FIG. 3. Of the components P1 to P6 in FIG. 3, FIG. 9 illustrates a display X1B-P3 corresponding to the display P3 and a composite sensor X1B-P6 corresponding to the composite sensor P6.

The display X1B-P3 is disposed near the front wall of the space B, for example. The composite sensor X1B-P6 is installed, for example, at a ceiling near the rear wall where a general view of the space B can be taken. The video camera of the composite sensor X1B-P6 captures an overhead view image of the space B. However, the composite sensor X1B-P6 does not have to be near the rear wall as long as it is at a position where a general view of the space B can be taken.

Each of the information processing devices Z1B to Z4B for student includes the components P1 to P6 of the information processing device P illustrated in FIG. 3. Of the components P1 to P6, FIG. 9 illustrates web cameras Z1B-P2 to Z4B-P2 each corresponding to the web camera P2 and displays Z1B-P3 to Z4B-P3 each corresponding to the display P3.

The web cameras Z1B-P2 to Z4B-P2 are installed, for example, on desks in front of the students U1B to U4B in the groups 1 to 4 seating, respectively. The web cameras Z1B-P2 to Z4B-P2 capture the faces (upper bodies) and the desks of all the students U1B to U4B in the groups 1 to 4, for the respective groups 1 to 4.

The displays Z1B-P3 to Z4B-P3 are placed horizontally with their screens facing up on the desks in front of the students U1B to U4B in the groups 1 to 4 seating, for the respective groups 1 to 4. The schematic diagrams of the displays Z1B-P3 to Z4B-P3 in FIG. 9 represent the desks used by the students U1B to U4B.

The composite sensors P6 (not illustrated) of the information processing devices Z1B to Z4B for student are installed, for example, on the top of the desks in front of the students U1B to U4B in the groups 1 to 4 seating, respectively, and acquire images of the hands of the students U1B to U4B and pieces of sensing data for detecting the movement of the hands of the students U1B to U4B, respectively.

Even in the case where the lecture/meeting system 1 is used in Scenario 5, the number of general information processing devices and the number of information processing devices for student in the space B are not limited to the numbers illustrated in FIG. 9. One or more information processing devices for facilitator may be disposed.

Symbols for the information processing device will now be described.

For all the information processing devices disposed in the space A and the space B, any information processing device is represented by symbol P when the information processing devices are not distinguished. Among them, the information processing device disposed in the space A is represented by symbol PA, and the information processing device disposed in the space B is represented by symbol PB.

For all the general information processing devices disposed in the space A and the space B, any general information processing device is represented by symbol X when the information processing devices are not distinguished. Among them, the general information processing devices disposed in the space A are represented by symbol XA, and the general information processing devices disposed in the space B are represented by symbol XB. When the general information processing devices XA disposed in the space A are individually represented, a consecutive number assigned to each general information processing device is added after symbol X (before symbol A), for example, as represented by X1A or X2A. When the general information processing devices XB disposed in the space B are individually represented, a consecutive number assigned to each general information processing device is added after symbol X (before symbol B), for example, as represented by X1B or X2B.

For all the information processing devices for teacher (for facilitator) disposed in the space A and the space B, any information processing device for teacher is represented by symbol Y when the information processing devices are not distinguished. Among them, the information processing devices for teacher disposed in the space A are represented by symbol YA, and the information processing devices for teacher disposed in the space B are represented by symbol YB. When the information processing devices YA for teacher disposed in the space A are individually represented, a consecutive number assigned to each information processing device is added after symbol Y (before symbol A), for example, as represented by Y1A or Y2A. When the information processing devices YB for teacher disposed in the space B are individually represented, a consecutive number assigned to each information processing device is added after symbol Y (before symbol B), for example, as represented by Y1B or Y2B.

For all the information processing devices for student (for participant) disposed in the space A and the space B, any information processing device for student is represented by symbol Z when the information processing devices are not distinguished. Among them, the information processing devices for student disposed in the space A are represented by symbol ZA, and the information processing devices for student disposed in the space B are represented by symbol ZB. When the information processing devices ZA for student disposed in the space A are individually represented, a consecutive number assigned to each information processing device is added after symbol Z (before symbol A), for example, as represented by Z1A or Z2A. When the information processing devices ZB for student disposed in the space B are individually represented, a consecutive number assigned to each information processing device is added after symbol Z (before symbol B), for example, as represented by Z1B or Z2B.

For the components P2 to P6 of each information processing device P in FIG. 3, when the information processing devices P are not distinguished, the components P2 to P6 are used as they are. When the information processing devices P are distinguished by some symbol (X, Y, Z, XA, XB, YA, YB, ZA, ZB, X1A, Y1A, . . . ), for the components P2 to P6 included in each information processing device P, the symbol for the information processing device is followed by “-” plus the corresponding symbol of the components P2 to P6.

The web camera P2, the display P3, the microphone P4, the speaker P5, and the composite sensor P6 of the general information processing device X are sometimes referred to as the general web cameras P2, the general display P3, the general microphone P4, the general speaker P5, and the general composite sensor P6, respectively, without using the term “information processing device X”. The same applies to the web camera P2, the display P3, the microphone P4, the speaker P5, and the composite sensor P6 of each of the information processing device Y for teacher and the information processing device Z for student.

(Example of Operation Screen 41)

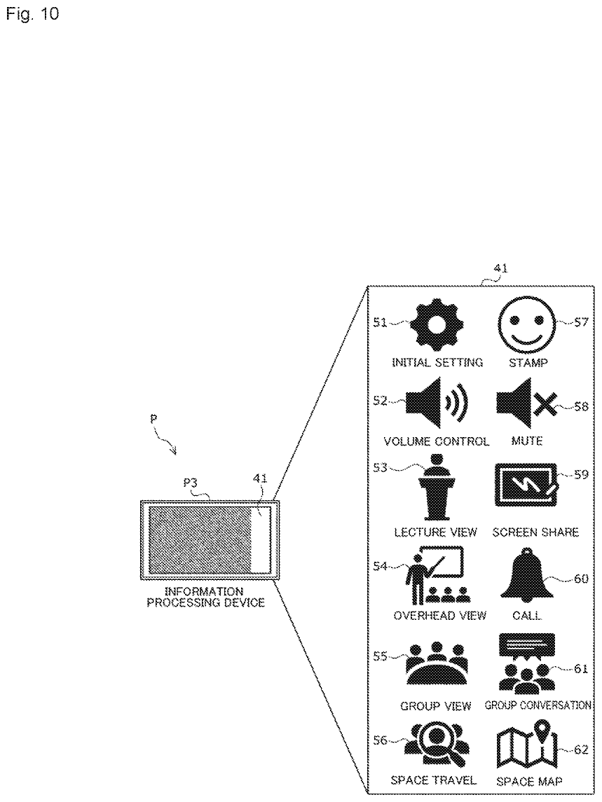

FIG. 10 is a diagram illustrating an example of an operation screen displayed on the display P3 of each information processing device P.

The operation screen 41 of FIG. 10 is displayed on the right side of the display P3 of each information processing device P, for example. The operation screen 41 may be temporarily displayed on the display P3 only when some user operation is performed on the touch panel or the like of the display P3.

A list of a plurality of types of operation icons is displayed in the operation screen 41. The operation icons displayed as a list include, for example, an initial setting icon 51, a volume setting icon 52, a lecture view icon 53, an overhead view icon 54, a group view icon 55, a space travel icon 56, a stamp icon 57, a mute icon 58, a screen share icon 59, a call icon 60, a group conversation icon 61 and a space map icon 62.

On any information processing device P, when any one of the operation icons in the operation screen 41 of the display P3 is clicked (selected/operated for execution), processing corresponding to the clicked operation icon is executed.

The information processing device P that the user is operating according to a guide screen such as the operation screen 41 displayed on the display P3 is referred to as the information processing device P as the current target for operation.

The initial setting icon 51 is an operation icon for performing a variety of initial settings. Initial setting processing for the initial setting icon 51 being clicked will be described later.

The volume setting icon 52 is an operation icon for setting (adjusting) the output volume from the speaker P5 of the information processing device P as the current target for operation. After the volume setting icon 52 is clicked, the volume is changed by a predetermined user operation.

The lecture view icon 53 is an operation button for displaying an image of the teacher on the display X-P3 of the general information processing device X in the space in which the students are present. Lecture view processing for the lecture view icon 53 being clicked will be described later.

The overhead view icon 54 is an operation button for displaying an overhead view image of the space in which the students are present on the display X-P3 of the general information processing device X in the space in which the teacher is present. Overhead view processing for the overhead view icon 54 being clicked will be described later.

The group view icon 55 is an operation button for displaying an image of the student(s) on the display Y-P3 of the information processing device Y for teacher. Group view processing for the group view icon 55 being clicked will be described later.

The space travel icon 56 is an operation button for displaying, on the information processing device Y for teacher and the information processing device Z for student, a space map (described later) of the space in which the students are present, and a virtual travel position of the teacher is specified and displayed in the space map. Space travel processing for the space travel icon 56 being clicked will be described later.

The stamp icon 57 is an operation icon for displaying a stamp representing the teacher's own emotion on the display Z-P3 of the information processing device Z for student. When the stamp icon 57 is clicked on the display Y-P3 of the information processing device Y for teacher and then a stamp is selected from among a plurality of stamp candidates representing emotions and the like, the selected stamp is displayed on the display Z-P3 for student.

The mute icon 58 is an operation icon for setting the output sound volume from the speaker P5 of the information processing device P as the current target for operation to zero (mute).

The screen share icon 59 is an operation button for displaying an image displayed on the display P3 of the information processing device P as the current target for operation on the display P3 of a specified information processing device P other than the information processing device as the current target for operation.

The call icon 60 is an operation icon for a student to call the teacher (request for group conversation). Call processing for the call icon 60 being clicked will be described later.

The group conversation icon 61 is an operation button for the teacher to have a conversation with the students (students in a predetermined group) through voice communication between the information processing device Y for teacher and the information processing device(s) Z for student. Group conversation processing for the group conversation icon 61 being clicked will be described later.

The space map icon 62 is an operation button for displaying a space map of the space A or the space B on the display Y-P3 of the information processing device Y for teacher or the display Z-P3 of the information processing device Z for student.

### Example 1: Example of Initial Setting Processing

(Initial Setting)

An example of initial setting processing will be described that is performed before a class associated with Scenario 5 is started in the configuration of the lecture/meeting system 1 in FIG. 4, the configuration of the information processing system 11A in the space A in FIG. 8, and the configuration of the information processing system 11B in the space B in FIG. 9.

An operation for the initial setting is performed, for example, by an administrator who manages the installation and operation of the lecture/meeting system 1 and the like. The administrator clicks the initial setting icon 51 in the operation screen 41 of FIG. 10 displayed on the display X1A-P3 of the general information processing device X1A in the space A (see FIG. 8), for example. When the initial setting icon 51 is clicked, an initial setting menu screen is displayed on the general display X1A-P3.

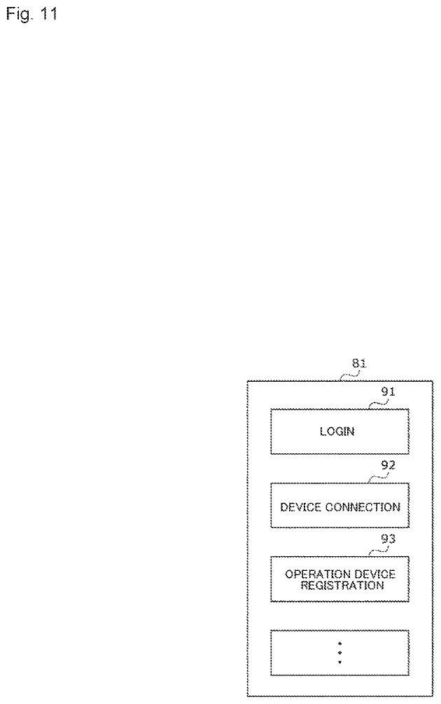

FIG. 11 is a diagram illustrating an example of the initial setting menu screen. In the initial setting menu screen 81, a login button 91, a device connection button 92, an operation device registration button 93, and so on are displayed. The administrator presses (clicks) a button corresponding to an item to be set in the initial setting menu screen 81.

(Login)

First, the administrator presses the login button 91 and enters login information (user ID, password, etc.) required for logging in to the cloud service 12. As a result, the information processing device X1A as the current target for operation logs in to the cloud service 12 (see FIG. 4), so that the cloud service 12 can be used via the network 13 (becomes online). When the information processing device X1A becomes online, the information processing device X1A becomes available for use in the lecture/meeting system 1.

The administrator performs a login operation on all the information processing devices P used in the space A and the space B, and sets all the information processing devices P to be online.

In the login processing, in FIG. 5, the administrator's login operation is input from the input unit P14 of the information processing device P as the current target for operation, and login information and the like are supplied to the processing unit P22. The processing unit P22 transmits the login information to the cloud service 12 via the communication unit P11. In FIG. 6, the processing unit 26 of the cloud service 12 receives the login information from the information processing device P as the current target for operation via the communication unit 21. The processing unit P22 collates the received login information with valid login information stored in advance in the data storage unit 27. As a result of the collation, if the received login information matches the valid login information, the information processing device P as the current target for operation is permitted to log in to the cloud service 12. The device registration unit 24 of the cloud service 12 registers the name (device ID) and the like of the logged-in information processing device P.

(Device Connection)

When all the information processing devices P in the space A and the space B are set to be online, the administrator presses, for example, the device connection button 92 in the initial setting menu screen 81 in FIG. 11, which is displayed on the general display X1A-P3 in the space A (see FIG. 8). As a result, a list (connection candidate list) of names (device IDs) of other information processing devices P that are online is displayed on the general display X1A-P3.

The administrator specifies, from among the connection candidate list, an information processing device P to which the information processing device X1A is to be connected for direct communication without passing through the cloud service 12. For example, the administrator specifies the general information processing device X1B (see FIG. 9) in the space B as the target for connection for the information processing device X1A.

The administrator also performs the device connection operation on the information processing device X1B specified as the target for connection with the information processing device X1A in the same manner as the device connection operation on the information processing device X1A. Then, the administrator specifies the information processing device X1A as the target for connection for the information processing device X1B.

As a result, the information processing device X1A and the information processing device X1B are specified as the targets for interconnection.

The information processing device X1A and the information processing device X1B, which are specified as the targets for interconnection in this manner, are connected in Peer-to-Peer (P2P). For example, a mechanism of Web Real-Time Communication (WebRTC) is used for the P2P connection.

The administrator performs such a device connection operation on two information processing devices P to be connected to each other in P2P. Specifically, the administrator specifies the information processing device X1A and the information processing device X1B as the targets for interconnection to establish a P2P connection. In addition, the information processing device Y1A for teacher in the space A (see FIG. 8) and the information processing devices Z1B to Z4B for student in the space B (see FIG. 9) are specified as being connected to each other to establish a P2P connection between them.

In the device connection processing, in FIG. 5, the administrator's operation for specifying the information processing device P as the target for connection is input from the input unit P14 of the information processing device P as the current target for operation, and is supplied to the processing unit P22. The processing unit P22 transmits, to the cloud service 12, information on the information processing device P as the target for connection, which is specified by the administrator, via the communication unit P11.

In FIG. 6, the matching unit 25 of the cloud service 12 receives the information on the information processing device P as the target for connection from the information processing device P as the current target for operation via the communication unit 21. The matching unit 25 has also received information on the information processing devices P as the targets for connection, which were specified by the administrator on other information processing devices P being online. When the information processing device P requested as the target for connection from the information processing device P as the current target for operation has requested to connect to the information processing device P as the current target for operation, the matching unit 25 transmits connection information for P2P connection to the information processing device P as the current target for operation and the information processing device P as the target for connection, via the communication unit 21. Based on the connection information from the cloud service 12, the processing units 26 of the information processing device P as the current target for operation and the information processing device P as the target for connection establish a P2P connection between the respective communication units 21.

(Operation Device Registration)

The administrator presses the operation device registration button 93 in the initial setting menu screen 81 in FIG. 11, which is displayed on the display P3 of the information processing device P. As a result, devices (components P2 to P6 in FIG. 3) included in the information processing devices P being online are retrieved. To retrieve the devices, for example, the UPnP device discovery mechanism is used.

The retrieval result is displayed as a list (device list) of names (device IDs, etc.) of the detected devices on the display P3 of the information processing device P as the current target for operation.

In the device list, the administrator specifies a device(s) to be operable in the information processing device P as the current target for operation. As a result, the device specified in the device list is registered in the information processing device P as the current target for operation as the device(s) operable in the information processing device P as the current target for operation.

The administrator performs such an operation device registration operation on a specific information processing device P. This operation device registration operation enables devices (components P2 to P6 in FIG. 3 and the like) connected to any other information processing device P to be remotely operated from, for example, the information processing device Y1A for teacher in the space A, which is available for a teacher.

In the device retrieval, devices connected to the network 13 are retrieved in addition to the devices connected to the PC main body P1 of the information processing device P being online.

The components P2 to P6 of the information processing device P in FIG. 3 may be connected to the network 13 instead of being directly connected to the PC main body P1 of the information processing device P. In this case, the components P2 to P6 connected to the network 13 are registered as devices to be operated by the information processing device P, for example. Information can be exchanged between the components P2 to P6 connected to the network 13 and the information processing device P via the network 13. This makes it possible to use the components P2 to P6 connected to the network 13 as parts of the information processing device P in the same way as the case where they are directly connected to the PC main body P1 of the information processing device P.

In order to prevent erroneous operations, specific devices may be restricted as being operable for each information processing device P.

(Flow of Processing to Connect Devices in Initial Setting)

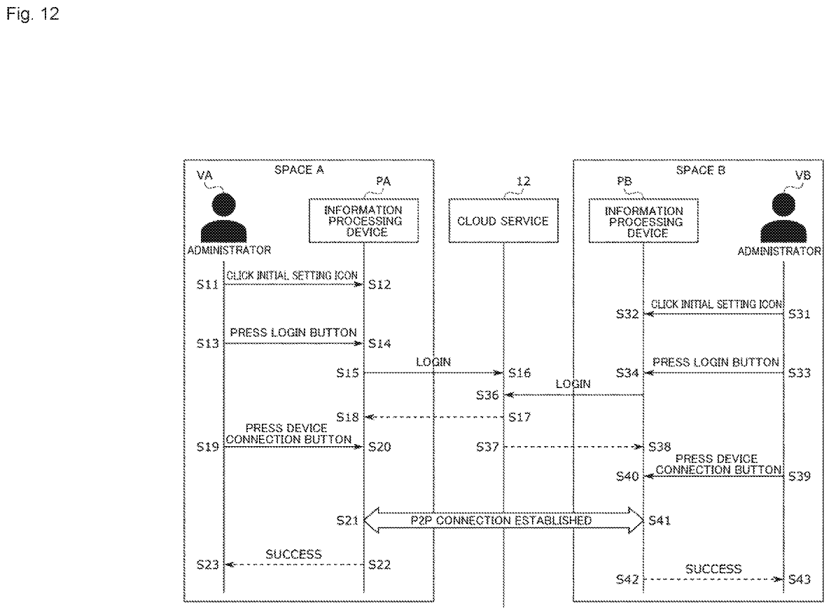

FIG. 12 is a sequence diagram illustrating an example of a flow of processing to connect devices in an initial setting for the lecture/meeting system 1. FIG. 12 illustrates a case where a predetermined information processing device PA in a space A and a predetermined information processing device PB in a space B are connected in P2P.

In step S11, an administrator VA clicks the initial setting icon 51 (see FIG. 10) in the operation screen 41 on the display PA-P3 of the information processing device PA in the space A. The processing proceeds from Step S11 to Step S12.

In step S12, the information processing device PA displays the initial setting menu screen 81 (see FIG. 11) on the display PA-PA in response to the user operation in step S11. The processing proceeds from step S12 to step S13.

In step S13, the administrator VA presses the login button 91 in the initial setting menu screen 81. The administrator VA enters information necessary for login (login information such as a user ID and a password). The processing proceeds from step S13 to step S14.

In step S14, the information processing device PA receives the login operation in step S13. The information processing device PA also acquires the login information entered in step S13. The processing proceeds from step S14 to step S15.

In step S15, the information processing device PA accesses the cloud service 12 (see FIG. 4) via the network 13, and transmits the login information received in step S14 to the cloud service 12 to attempt to log in. The processing proceeds from step S15 to step S16.

In step S16, the cloud service 12 authenticates the login information transmitted from the information processing device PA in step S15. If the authentication is successful, the cloud service 12 permits the information processing device PA to log in, so that the information processing device PA is permitted to use the cloud service 12. If the authentication is not successful, the cloud service 12 does not permit to log in. Details of the case where the authentication is not successful are not described herein. The processing proceeds from step S16 to step S17.

In step S17, the cloud service 12 transmits a notification indicating successful login to the information processing device PA. The processing proceeds from step S17 to step S18.

In step S18, information processing device PA receives the login notification transmitted from cloud service 12 in step S17. The information processing device PA displays a notification indicating successful login on the display PA-P3 to notify the administrator VA of that. The processing proceeds from step S18 to step S19.

In step S19, the administrator VA presses the device connection button 92 (see FIG. 11) in the initial setting menu screen 81 on the display PA-P3 of the information processing device PA. Then, the administrator VA further specifies the device ID of the information processing device PB in the space B to establish a P2P connection with the information processing device PA. The processing proceeds from step S19 to step S20.

In step S20, the information processing device PA receives the device connection operation in step S19. The information processing device PA further acquires the device ID specified in step S19. The processing proceeds from step S20 to step S21.

In step S21, the information processing device PA establishes a P2P connection with the information processing device PB associated with the device ID specified in step S20, using the P2P connection mechanism of WebRTC.

It is assumed that, prior to step S21, the information processing device PB associated with the device ID acquired in step S20 has logged in to the cloud service 12 in the same way as the information processing device PA, and the device ID of the information processing device PA has been specified as the target for connection to establish a P2P connection with the information processing device PB. If the information processing device PA and the information processing device PB are specified as the targets for interconnection, the cloud service 12 establishes a P2P connection between the information processing device PA and the information processing device PB. The processing proceeds from step S21 to step S22.

In step S22, the information processing device PA displays, on the display PA-P3 of information processing device PA, a notification indicating that the P2P connection with the information processing device PB as the target for connection is successful, to notify the administrator VA of that. The processing proceeds from step S22 to step S23.

In step S23, the administrator VA confirms the notification in step S22.

On the other hand, in the space B, an administrator VB performs the same operation on the information processing device PB as the operation on the information processing device PA, and the information processing device PB performs the same processing as the information processing device PA. The processing of steps S31 to S43 related to the processing performed on the information processing device PB in the space B by the administrator VB is the same as the processing of steps S11 to S23, and accordingly, the description thereof will be omitted.

(Flow of Operation Device Registration Processing in Initial Setting)

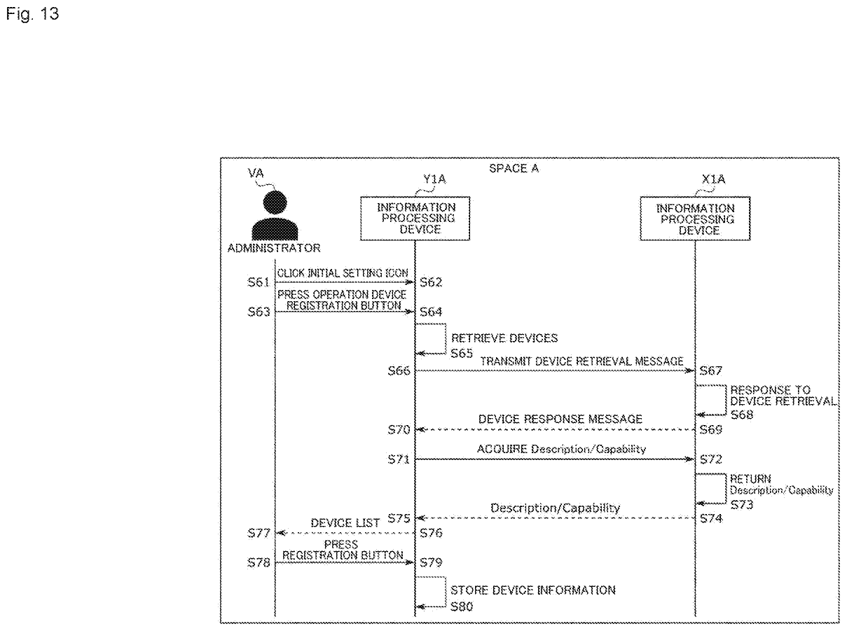

FIG. 13 is a sequence diagram illustrating an example of a flow of operation device registration processing in an initial setting for the lecture/meeting system 1. FIG. 13 illustrates a case where an operation device is registered to be operable in the information processing device Y1A for teacher in the space A (see FIG. 8) and the operation device is registered from among devices (components P2 to P6 in FIG. 3) included in the information processing device Y1A and devices (components P2 to P6 in FIG. 3) included in the information processing device X1A connected to the same network (local network) as the information processing device Y1A.

In step S61, the administrator VA clicks the initial setting icon 51 (see FIG. 10) in the operation screen 41 on the display Y1A-P3 (see FIG. 8) of the information processing device Y1A. The processing proceeds from step S61 to step S62.

In step S62, the information processing device Y1A displays the initial setting menu screen 81 (see FIG. 11) on the display Y1A-P3 for teacher T1A in response to the user operation in step S61. The processing proceeds from step S62 to step S63.

In step S63, the administrator VA presses the operation device registration button 93 in the initial setting menu screen 81. The processing proceeds from step S63 to step S64.

In step S64, the information processing device Y1A receives the operation device registration operation in step S63. The processing proceeds from step S64 to step S65.

In step S65, the information processing device Y1A retrieves devices included in the information processing device Y1A (devices connected to its own PC main body P1), using the UPnP device discovery mechanism. The processing proceeds from step S65 to step S66.

In step S66, the information processing device Y1A transmits a device retrieval message (device retrieval request) to the information processing device X1A. The processing proceeds from step S66 to step S67.

In step S67, the information processing device X1A receives the device retrieval message transmitted from the information processing device Y1A in step S66. The processing proceeds from Step s67 to step S68.

In step S68, the information processing device X1A retrieves devices included in the information processing device X1A (devices connected to its own PC main body P1), using the UPnP device discovery mechanism. The processing proceeds from step S68 to step S69.

In step S69, the information processing device X1A transmits information on the devices detected in step S63 as a device response message to the information processing device Y1A. The processing proceeds from step S69 to step S70.

In step S70, the information processing device Y1A receives the device response message transmitted from the information processing device X1A in step S69. The processing proceeds from step S70 to step S71.

In step S71, the information processing device Y1A transmits a Description/Capability acquisition request to the information processing device X1A. The processing proceeds from step S71 to step S72.

In step S72, the information processing device X1A receives the Description/Capability acquisition request transmitted from the information processing device Y1A in step S71. The processing proceeds from step S72 to step S73.

In step S73, the information processing device X1A acquires information such as the functions of the devices detected in step S68 as Description/Capability. The processing proceeds from step S73 to step S74.

In step S74, the information processing device X1A transmits the Description/Capability acquired in step S73 to the information processing device Y1A. The processing proceeds from step S74 to step S75.

In step S75, the information processing device Y1A receives the Description/Capability transmitted from the information processing device X1A in step S74. The processing proceeds from step S75 to step S76.

In step S76, based on the devices detected in step S65 and the device response message received in step S70, the information processing device Y1A displays a list of devices that are operable in the information processing device Y1A on the display Y1A-P3 (FIG. 8) to notify the administrator VA of that. The processing proceeds from step S76 to step S77.

In step S77, the administrator VA confirms the device list displayed on the display Y1A-P3. The processing proceeds from step S77 to step S78.

In step S78, the administrator VA specifies a device(s) to be operable in the information processing device Y1A and presses a predetermined registration button. The processing proceeds from step S78 to step S79.

In step S79, the information processing device Y1A receives the specification of the device(s) and the operation for registration in step S78. The processing proceeds from step S79 to step S80.

In step S80, the information processing device Y1A stores the information such as the Description/Capability received in step S75 as device information on the device(s) specified in step S79.

### Example 2: Example of (Lecture View) Processing at Start of Class

An example of lecture view processing will be described that is performed when a class associated with Scenario 5 is started in the configuration of the lecture/meeting system 1 in FIG. 4, the configuration of the information processing system 11A in the space A in FIG. 8, and the configuration of the information processing system 11B in the space B in FIG. 9.

When a class is tarted, the teacher T1A in the space A in which the students are present clicks the lecture view icon 53 in the operation screen 41 in FIG. 10, which is displayed in the display Y1A-P3 (see FIG. 8) of the information processing device Y1A for teacher (display Y1A-P3 for teacher). When the lecture view icon 53 is clicked, lecture view processing is performed and the lecture/meeting system 1 is set to a lecture view mode.

In the lecture view mode, an image captured by the web camera X1A-P2 (see FIG. 8) of the general information processing device Y1A in the space A (general web camera X1A-P2) is displayed on the display X1B-P3 (see FIG. 9) of the general information processing device X1B in the space B (general display X1B-P3). The web camera X1A-P2 is installed so as to capture the position where the teacher T1A teaches from the front. As a result, an image of the teacher T1A is displayed on the general display X1B-P3 in the space B.

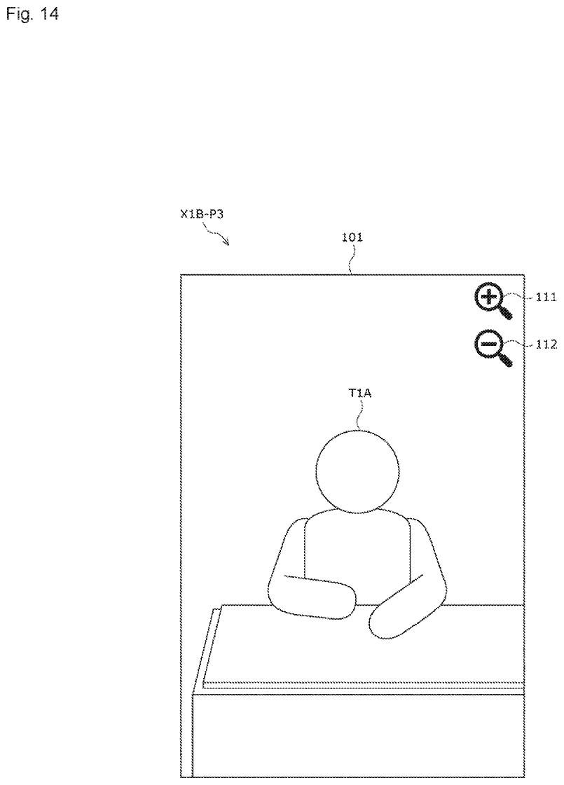

FIG. 14 illustrates an example of an image displayed on the general display X1B-P3 in the space B in which students are present in the lecture view mode.

In FIG. 14, an image 101 captured by the general web camera X1A-P2 is displayed on the display X1B-P3. The image 101 is an image of the teacher T1A captured from the front. On the general display X1B-P3 in the space B, a zoom-in icon 111 and a zoom-out icon 112 are superimposed on the image 101. Each time the zoom-in icon 111 is clicked, the image 101 is displayed to be enlarged step by step. Each time the zoom-out icon 112 is clicked, the image 101 is displayed to be reduced step by step.

In the lecture view mode, a voice of the teacher T1A and the like input from the microphone X1A-P4 of the general information processing device X1A (general microphone X1A-P4) is output from the speaker X1B-P5 of the general information processing device X1B in the space B (general speaker X1B-P5 in the space B). The speaker PX1B-P5 is disposed, for example, near the display X1B-P3.

The image of the teacher displayed on the general display X1B-P3 in the space B and the voice of the teacher T1A and the like output from the general speaker X1B-P5 make the students U1B to U4B in the space B (see FIG. 9) feel as if the teacher T1A is actually teaching in the space B.

In the lecture view mode, an image captured by the web camera X1B-P2 of the general information processing device X1B in the space B (see FIG. 9) is displayed on the display X1A-P3 (see FIG. 8) of the general information processing device X1A in the space A in which the teacher T1A is present (general display X1A-P3). The general web camera X1B-P2 is installed, for example, near the display X1B-P3, and captures the space B from the front. As a result, an image of students (some students on the front side) captured from the front is displayed on the general display X1A-P3 in the space A.

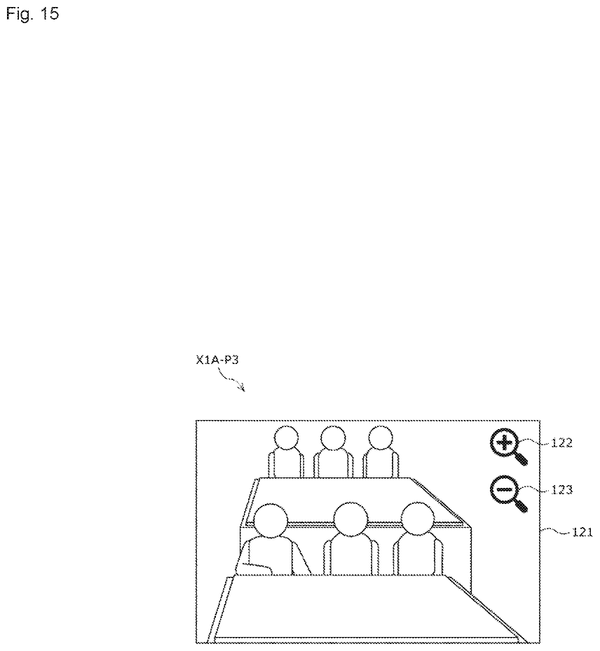

FIG. 15 illustrates an example of an image displayed on the general display X1A-P3 in the space A in which the teacher T1A is present in the lecture view mode.

In FIG. 15, an image 121 captured by the general web camera X1B-P2 in the space B is displayed on the display X1A-P3. The image 121 is an image of the students in the space B captured from the front. On the display X1A-P3, a zoom-in icon 122 and a zoom-out icon 123 are superimposed on the image 121. Each time the zoom-in icon 122 is clicked, the image 121 is displayed to be enlarged step by step. Each time the zoom-out icon 123 is clicked, the image 121 is displayed to be reduced step by step.

In the lecture view mode, a voice(s) of the student(s) or the like input from the general microphone X1B-P4 in the space B is output from the speaker X1A-P5 of the general information processing device X1A in the space A. The speaker X1A-P5 is disposed, for example, near the general display X1A-P3 in the space A.

In the lecture view processing, in FIG. 5, the image 101 (see FIG. 14) of the teacher T1A captured by the general web camera X1A-P2 in the space A is input from the image input unit P18 of the general information processing device X1A in the space A and supplied to the data transmission unit P12. The voice of the teacher T1A input from the general microphone X1A-P4 is input from the sound input unit P16 of the information processing device X1A for teacher and supplied to the data transmission unit P12. The data transmission unit P12 transmits the image and voice supplied from the image input unit P18 and the sound input unit P16 to the general information processing device X1B in the space B, which is connected in P2P, via the communication unit P11.

The data reception unit P13 of the general information processing device X1B in the space B receives the image and voice of the teacher T1A transmitted from the general information processing device X1A in the space A via the communication unit P11. The data reception unit P13 supplies the received image to the image output unit P19 and supplies the received voice to the sound output unit P17. The image output unit P19 outputs the image of the teacher supplied from the data reception unit P13 to the general display X1B-P3 in the space B (displays the image on the display X1B-P3). The sound output unit P17 outputs the voice of the teacher supplied from the data reception unit P13 from the general speaker X1B-P5 in the space B.

On the other hand, the image 121 (see FIG. 15) of the students captured by the general web camera X1B-P2 in the space B is input from the image input unit P18 of the general information processing device X1B in the space B and supplied to the data transmission unit P12. The voice(s) of the student(s) input from the general microphone X1B-P4 is input from the sound input unit P16 of the general information processing device X1B and supplied to the data transmission unit P12. The data transmission unit P12 transmits the image and voice supplied from the image input unit P18 and the sound input unit P16 to the general information processing device X1A in the space A, which is connected in P2P, via the communication unit P11.

The data reception unit P13 of the general information processing device X1A in the space A receives the image and voice(s) of the students transmitted from the general information processing device X1B in the space B via the communication unit P11. The data reception unit P13 supplies the received image to the image output unit P19 and supplies the received voice(s) to the sound output unit P17. The image output unit P19 outputs the image of the students from the data reception unit P13 to the general display X1A-P3 in the space A. The sound output unit P17 outputs the voice of the teacher supplied from the data reception unit P13 from the general speaker X1A-P5 in the space A.

According to the lecture view of the lecture/meeting system 1, the image of the students in the space B, which is displayed on the general display X1A-P3 in the space A, and the voice(s) of the student(s) and the like output from the general speaker X1A-P5 make it possible for the teacher T1A in the space A to feel as if the teacher T1A is actually teaching in the space B.

(Flow of Lecture View Processing)

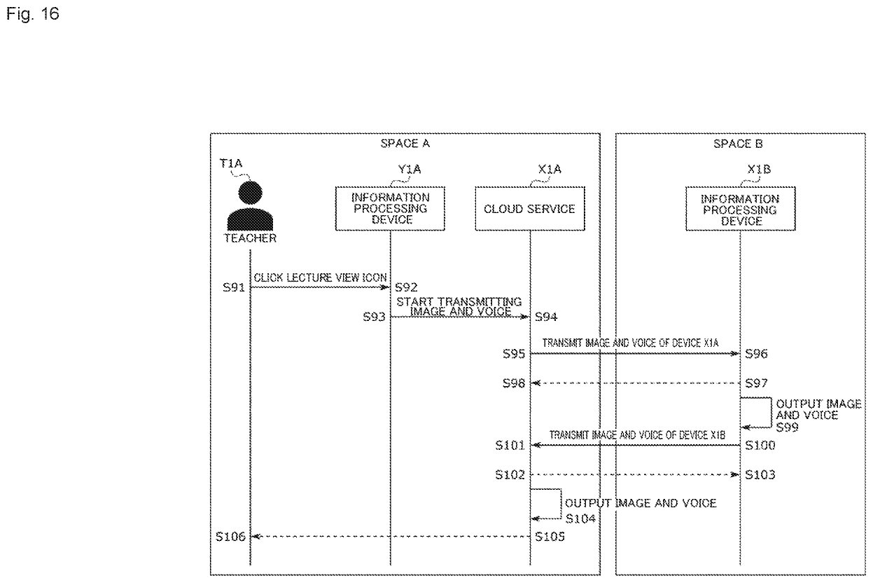

FIG. 16 is a sequence diagram illustrating an example of a flow of lecture view processing in the lecture/meeting system 1.

It is assumed that necessary P2P connection has been established between the information processing devices according to an initial setting before the lecture view processing is started.

In step S91, the teacher T1A clicks the lecture view icon 53 (see FIG. 10) in the operation screen 41 on the display Y1A-P3 (see FIG. 8) of the information processing device Y1A for teacher in the space A. The processing proceeds from step S91 to step S92.

In step S92, the information processing device Y1A receives the operation in step S91. The processing proceeds from step S92 to step S93.

In step S93, the information processing device Y1A transmits an instruction to start transmitting an image and a voice to the general information processing device X1A in the space A (see FIG. 8). The processing proceeds from step S93 to step S94.

In step S94, the information processing device X1A receives the instruction to start transmitting an image and a voice, which has been transmitted from the information processing device Y1A in step S93. The processing proceeds from step S94 to step S95.

In step S95, the information processing device X1A transmits an image and a voice, which have been acquired by its own general web camera X1A-P2 and microphone X1A-P4, to the general information processing device X1B in the space B (see FIG. 9). The processing proceeds from step S95 to step S96.

In step S96, the information processing device X1B receives the image and voice transmitted from the information processing device X1A in step S95. The processing proceeds from step S96 to step S97.

In step S97, the information processing device X1B transmits a response indicating that the image and voice have been received to the information processing device X1A. The processing proceeds from Step S97 to step S98.

In step S98, the information processing device X1A receives the response transmitted from the information processing device X1B in step S97. After that, images and voices are continuously transmitted from the information processing device X1A to the information processing device X1B. The processing proceeds from step S98 to step S99.

In step S99, the information processing device X1B outputs the image and voice transmitted from the information processing device X1A from its own general display X1B-P3 and speaker X1B-P5. As a result, the image 101 of the teacher as illustrated in FIG. 14 is displayed on the display X1B-P3. The processing proceeds from step S99 to step S100.

In step S100, the information processing device X1B transmits the image and voice acquired by its own general web camera X1B-P2 and microphone X1B-P4 to the information processing device X1A. The processing proceeds from step S100 to step S101.

In step S101, the information processing device X1A receives the image and voice transmitted from the information processing device X1B in step S100. The processing proceeds from step S101 to step S102.

In step S102, the information processing device X1A transmits a response indicating that the image and voice have been received to the information processing device X1B. The processing proceeds from step S102 to step S103.

In step S103, the information processing device X1B receives the response transmitted from the information processing device X1A in step S102. After that, images and voices are continuously transmitted from the information processing device X1B to the information processing device X1A. The processing proceeds from step S103 to step S104.

In step S104, the information processing device X1A outputs the image and voice transmitted from the information processing device X1B from its own general display X1A-P3 and speaker X1A-P5. As a result, the image 121 of the students as illustrated in FIG. 15 is displayed on the display X1A-P3. The processing proceeds from step S104 to step S105.

In step S105, the information processing device X1A transmits to the information processing device Y1A a notification indicating that the transmission of the image and voice in the lecture view has been properly started, and the information processing device Y1A displays the notification on the display Y1A-P3. The processing proceeds from step S105 to step S106.

In step S106, the teacher T1A confirms the content displayed in step S106.

### Example 3: Overhead View Processing Example

An example of overhead view processing will be described that is performed when a class associated with Scenario 5 is being given in the configuration of the lecture/meeting system 1 in FIG. 4, the configuration of the information processing system 11A in the space A in FIG. 8, and the configuration of the information processing system 11B in the space B in FIG. 9.

If the teacher T1A wishes to know about the overall situation of the space B (if the teacher T1A wishes to sense the atmosphere in the place), for example, the teacher T1A clicks the overhead view icon 54 in the operation screen 41 of FIG. 10, which is displayed on the display Y1A-P3 (see FIG. 8) of the information processing device Y1A for teacher. When the overhead view icon 54 is clicked, overhead view processing is performed and the lecture/meeting system 1 is set to an overhead view mode.

In the overhead view mode, an overhead view captured by the video camera of the general composite sensor X1B-P6 in the space B (see FIG. 9) is displayed on the general display X1A-P3 in the space A (see FIG. 8). The composite sensor X1B-P6 is a composite sensor of the general information processing device X1B. The composite sensor X1B-P6 is installed, for example, on the ceiling or the like near the rear wall in the space B, and captures the space B from a high rear position.

It is assumed that when the lecture/meeting system 1 is switched from the lecture view mode to the overhead view mode, only the image on the general display X1A-P3 is switched from the lecture view mode. It is also assumed that when the lecture/meeting system 1 is switched from the lecture view mode to the overhead view mode, the image displayed on the general display X1A-P3 is switched from the lecture view image to the overhead view image captured by the video camera of the composite sensor X1B-P6.

However, when the lecture/meeting system 1 is switched from the lecture view mode to the overhead view mode, the image displayed on the display X1A-P3 may be switched from the lecture view image to an image in which the lecture view image and the overhead view image are arranged vertically, for example. For example, each time the overhead view icon 54 is clicked, the image displayed on the display X1A-P3 may be switched between only the overhead view image and an image in which the lecture-view image and the overhead view image are arranged.

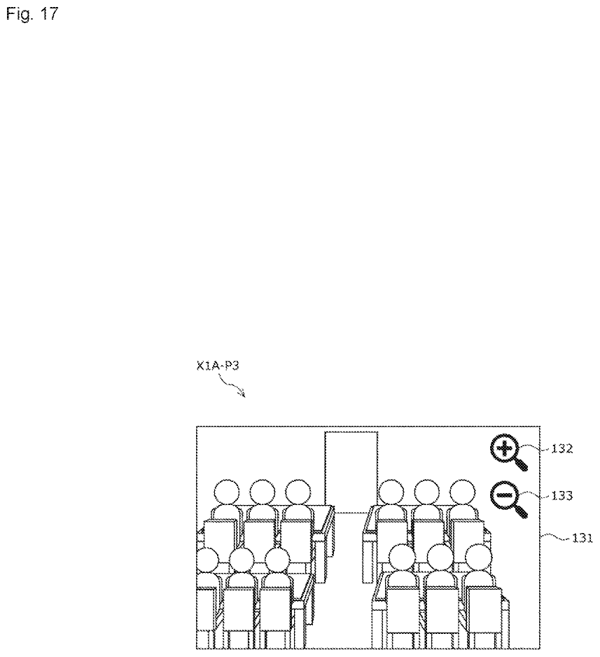

FIG. 17 illustrates an example of an image displayed on the general display X1A-P3 in the space A in which the teacher T1A is present in the overhead view mode.

In FIG. 17, an overhead view image 131 of the space B is displayed on the display X1A-P3. The overhead view image 131 is an image captured from a high rear position in the space B by the video camera of the composite sensor X1B-P6. The entire space B appears in the overhead view image 131. On the display X1A-P3, a zoom-in icon 132 and a zoom-out icon 133 are superimposed on the overhead view image 131. Each time the zoom-in icon 132 is clicked, the overhead view image 131 is displayed to be enlarged step by step, and each time the zoom-out icon 123 is clicked, the image 121 is displayed to be reduced step by step.

In the overhead view processing, in FIG. 5, the image 131 (see FIG. 17) of the students, from which a general view of substantially the entire space B (almost all the students) can be taken, captured by the video camera of the general composite sensor X1B-P6 in the space B is input from the image input unit P18 of the general information processing device X1B in the space B and supplied to the data transmission unit P12. The data transmission unit P12 transmits the overhead view image supplied from the image input unit P18 to the general information processing device X1A in the space A, which is connected in P2P, via the communication unit P11.

The data reception unit P13 of the general information processing device X1A in the space A receives the overhead view image 131 transmitted from the general information processing device X1B in the space B via the communication unit P11, and supplies the overhead view image 131 to the image output unit P19. The image output unit P19 outputs the overhead view image 131 from the data reception unit P13 to the general display X1A-P3.

According to the overhead view of the lecture/meeting system 1, the overhead view image 131 displayed on the display X1A-P3 of the information processing device X1A makes it possible for the teacher T1A to sense the atmosphere of the entire space B even at a remote location.

(Flow of Overhead View Processing)

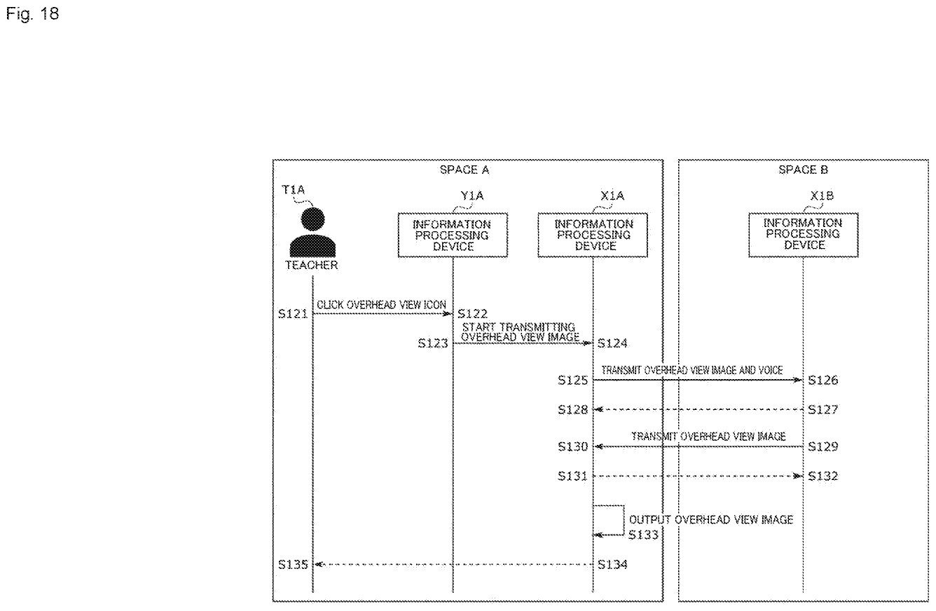

FIG. 18 is a sequence diagram illustrating an example of a flow of overhead view processing in the lecture/meeting system 1.

In step S121, the teacher T1A clicks the overhead view icon 54 (see FIG. 10) in the operation screen 41 on the display Y1A-P3 (see FIG. 8) of the information processing device Y1A for teacher in the space A. The processing proceeds from step S121 to step S122.

In step S122, the information processing device Y1A receives the operation in step S121. The processing proceeds from step S122 to step S123.

In step S123, the information processing device Y1A transmits an instruction to start transmitting an overhead view image to the general information processing device X1A in the space A. The processing proceeds from step S123 to step S124.

In step S124, the information processing device X1A receives the instruction to start transmitting an overhead view image, which has been transmitted from the information processing device Y1A in step S123. The processing proceeds from step S124 to step S125.

In step S125, the information processing device X1A transmits a request to transmit an overhead view image to the general information processing device X1B in the space B (see FIG. 9). The processing proceeds from step S125 to step S126.

In step S126, the information processing device X1B receives the request transmitted from the information processing device X1A in step S125. The processing proceeds from step S126 to step S127.

In step S127, the information processing device X1B transmits a response to the request received in step S126 to the information processing device X1A. The processing proceeds from step S127 to step S128.

In step S128, the information processing device X1A receives the response transmitted from the information processing device X1B in step S127. The processing proceeds from step S128 to step S129.

In step S129, the information processing device X1B transmits to the information processing device X1A an overhead view image captured by the video camera of its own general composite sensor X1B-P6. The processing proceeds from step S129 to step S130.

In step S130, the information processing device X1A receives the overhead view image transmitted from the information processing device X1B in step S129. The processing proceeds from step S130 to step S131.

In step S131, the information processing device X1A transmits to the information processing device X1B a response indicating that the overhead view image has been received from the information processing device X1B. The processing proceeds from step S131 to step S132.

In step S132, the information processing device X1B receives the response transmitted from the information processing device X1A in step S131. After that, overhead view images are continuously transmitted from the information processing device X1B to the information processing device X1A. The processing proceeds from step S132 to step S133.

In step S133, the information processing device X1A outputs the overhead view image transmitted from the information processing device X1B to its own general display X1A-P3. As a result, the overhead view image 131 as illustrated in FIG. 17 is displayed on the display X1A-P3. The processing proceeds from step S133 to step S134.

In step S134, the information processing device X1A transmits to the information processing device Y1A a notification indicating that the transmission of the overhead view image in the overhead view has been properly started, and the information processing device Y1A displays the notification on the display Y1A-P3. The processing proceeds from step S134 to step S135.

In step S135, the teacher T1A confirms the content displayed in step S134.

### Example 4: Group View Processing Example

An example of group view processing will be described that is performed when a class associated with Scenario 5 is being given in the configuration of the lecture/meeting system 1 in FIG. 4, the configuration of the information processing system 11A in the space A in FIG. 8, and the configuration of the information processing system 11B in the space B in FIG. 9.

If the teacher T1A wishes to know about the degree of interest of each of the groups 1 to 4 in the space B and the progress of a group work, for example, the teacher T1A clicks the group view icon 55 in the operation screen 41 of FIG. 10, which is displayed on the display Y1A-P3 (see FIG. 8) of the information processing device Y1A for teacher. When the group view icon 55 is clicked, group view processing is performed and the lecture/meeting system 1 is set to a group view mode.

In the group view mode, a list of images (referred to as group images) captured by the web cameras Z1B-P2 to Z4B-P2 of the information processing devices Z1B to Z4B for student in the space B (see FIG. 9) are displayed on the display Y1A-P3 for teacher in the space A (see FIG. 8) The web cameras Z1B-P2 to Z4B-P2 for student are placed on desks or the like in front of the students U1B to U4B in the groups 1 to 4 seating, respectively. The web cameras Z1B-P2 to Z4B-P2 for student capture the faces (upper bodies) and the desks of all the students U1B to U4B in the groups 1 to 4, for the respective groups 1 to 4.

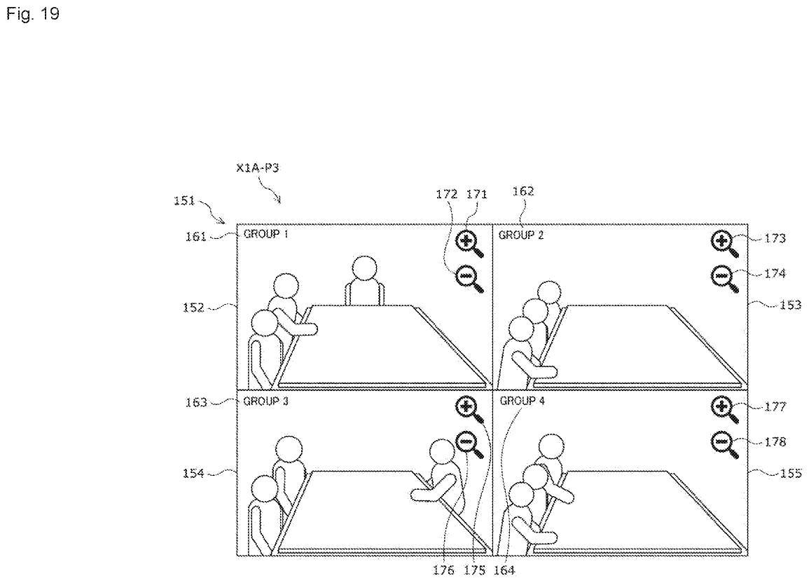

FIG. 19 illustrates an example of images displayed on the display Y1A-P3 of the information processing device Y1A for teacher in the group view mode.

In FIG. 19, a list image 151 including group images which are captured images of the groups 1 to 4 is displayed on the display Y1A-P3 for teacher. The list image 151 is an image in which group images 152 to 155 of the groups 1 to 4 are arranged in 2×2. The group images 152 to 155 of the groups 1 to 4 are images captured by the web cameras Z1B-P2 to Z4B-P2 for the students in the groups 1 to 4, respectively. The faces (upper bodies) of the students U1B to U4B in the groups 1 to 4 and their desktops appear in the group images 152 to 155.

On the display Y1A-P3, group names 161 to 164 of the groups appearing in the group images 152 to 155 are superimposed on the group images 152 to 155, respectively.

On the display Y1A-P3, zoom-in icons 171, 173, 175, and 177 and zoom-out icons 172, 174, 176, and 178 are superimposed on the group images 152 to 155, respectively. Each time any one of the zoom-in icons 171, 173, 175 and 177 is clicked, the corresponding one of the group images 152 to 155 is displayed to be enlarged step by step, and each time any one of the zoom-out icons 172, 174, 176, and 178 is clicked, the corresponding one of the group images 152 to 155 is displayed to be reduced step by step.

In the group view processing, in FIG. 5, the group images 152 to 155 of the groups 1 to 4 captured by the web cameras Z1B-P2 to Z4B-P2 for student in the space B are input from the image input units P18 of the information processing devices Z1B to Z4B for student and supplied to the data transmission units P12, respectively. The data transmission units P12 transmit the group images 152 to 155 supplied from the image input units P18 to the information processing device Y1A for teacher in the space A, which is connected in P2P, via the communication units P11, respectively.

The data reception unit P13 of the information processing device Y1A for teacher receives the group images 152 to 155 transmitted from the information processing devices Z1B to Z4B for student via the communication unit P11, and supplies the group images 152 to 155 to the image output unit P19. The image output unit P19 outputs the group images 152 to 155 supplied from the data reception unit P13 as the list image 151 (see FIG. 19) to the display Y1A-P3 for teacher.

According to the group view of the lecture/meeting system 1, the list image 151 of group images 152 to 155 displayed on the display Y1A-P3 for teacher makes it possible for the teacher T1A to confirm the performance of each group even at a remote location and thus to easily and immediately know about the degree of interest of each group and the progress of a group work.

(Group View Processing Example)

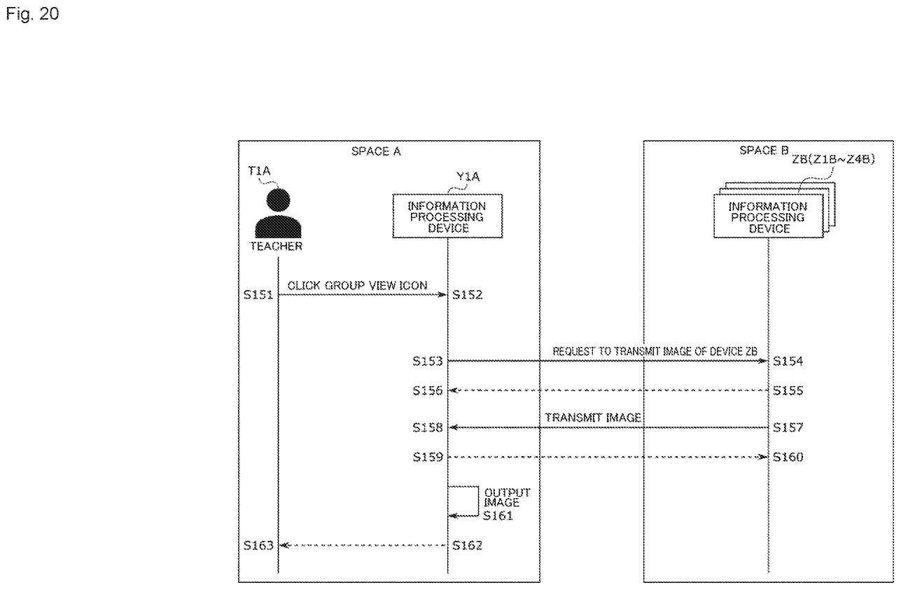

FIG. 20 is a sequence diagram illustrating an example of a flow of group view processing in the lecture/meeting system 1.

An information processing device ZB in FIG. 20 represents any one of the information processing devices, that is, all the information processing devices Z1B to Z4B for student disposed in the space B, and the processing of the information processing device ZB illustrated in FIG. 20 is to be implemented in each of the information processing devices Z1B to Z4B for student.

In step S151, the teacher T1A clicks the group view icon 55 (see FIG. 10) in the operation screen 41 on the display Y1A-P3 (see FIG. 8) of the information processing device Y1A for teacher in the space A. The processing proceeds from step S151 to step S152.

In step S152, the information processing device Y1A receives the operation in step S151. The processing proceeds from step S152 to step S153.

In step S153, the information processing device Y1A transmits a request to transmit a group image (an image from the web camera P2 (Z1B-P2 to Z4B-P2) of each information processing device ZB) to each information processing device ZB (Z1B to Z4B) for student in the space B. The processing proceeds from step S153 to step S154.

In step S154, the information processing device ZB receives the request transmitted from the information processing device Y1A in step S153. The processing proceeds from step S154 to step S155.

In step S155, the information processing device ZB transmits a response to the request received in step S154 to the information processing device Y1A. The processing proceeds from step S155 to step S156.

In step S156, the information processing device Y1A receives the response transmitted from the information processing device ZB in step S155. The processing proceeds from step S156 to step S157.

In step S157, the information processing device ZB transmits to the information processing device Y1A a group image captured by its own web camera ZB-P2 for student. The processing proceeds from step S157 to step S158.

In step S158, the information processing device Y1A receives the group image transmitted from the information processing device ZB in step S157. The processing proceeds from step S158 to step S159.

In step S159, the information processing device Y1A transmits to the information processing device ZB a response indicating that the group image has been received from the information processing device ZB. The processing proceeds from step S159 to step S160.

In step S160, the information processing device ZB receives the response transmitted from the information processing device Y1A in step S159. After that, group images are continuously transmitted from the information processing device ZB to the information processing device Y1A. The processing proceeds from step S160 to step S161.

In step S161, the information processing device Y1A outputs the group image transmitted from the information processing device ZB to its own display Y1A-P3 for teacher as one group image of the list image. At that time, the information processing device Y1A has received the group images from all the information processing devices Z1B to Z4B in the space B, and the list image 151 of the group images of the groups 1 to 4 as illustrated in FIG. 19 is displayed on the display Y1A-P3. The processing proceeds from step S161 to step S162.

In step S162, the information processing device Y1A displays on the display Y1A-P3 for teacher a notification indicating that transmission of the group image in the group view has been properly started. The processing proceeds from step S162 to step S163.

In step S163, the teacher T1A confirms the content displayed in step S162.

### Example 5: Group Conversation Processing Example

An example of group view processing will be described that is performed when a class associated with Scenario 5 is being given in the configuration of the lecture/meeting system 1 in FIG. 4, the configuration of the information processing system 11A in the space A in FIG. 8, and the configuration of the information processing system 11B in the space B in FIG. 9.

If the teacher T1A wishes to have an individual conversation with one of the groups 1 to 4 in the space B, for example, the teacher T1A clicks the group conversation icon 61 in the operation screen 41 of FIG. 10, which is displayed on the display Y1A-P3 (see FIG. 8) of the information processing device Y1A for teacher. Then, the teacher T1A specifies a group as the conversation party group. Any method may be used to specify a conversation party group. For example, a method of specifying a conversation party group may include displaying a group selection screen on the display Y1A-P3 in response to the group conversation icon 61 being clicked, thus allowing the teacher T1A to specify (select) a conversation party group on the selection screen. A method of specifying a conversation party group may include, in the group view mode, allowing to click a display portion of the group image of a conversation party group to specify the group, and then allowing the group conversation icon 61 to be clicked.

In the group conversation mode, a voice of the teacher or the like input from the microphone Y1A-P4 for teacher in the space A is output from the speaker ZB-P5 of the information processing device ZB for the students (group) used by the conversation party group. In addition, voices of the student and the like input from the microphone ZB-P4 for the conversation party group is output from the speaker Y1A-P5 for teacher.

For example, when the teacher T1A specifies the group 1 as a conversation party, a voice of the teacher T1A is output from the speaker Z1B-P5 of the information processing device Z1B (see FIG. 9) for the students U1B in the group 1 (for the group 1). In addition, voices of the students U1B and the like input from the microphone Z1B-P4 for the group 1 are output from the speaker Y1A-P5 for teacher.

In the group conversation mode, a group image captured by the web camera ZB-P2 for the conversation party group is displayed on the display Y1A-P3 for teacher in the space A (see FIG. 8).

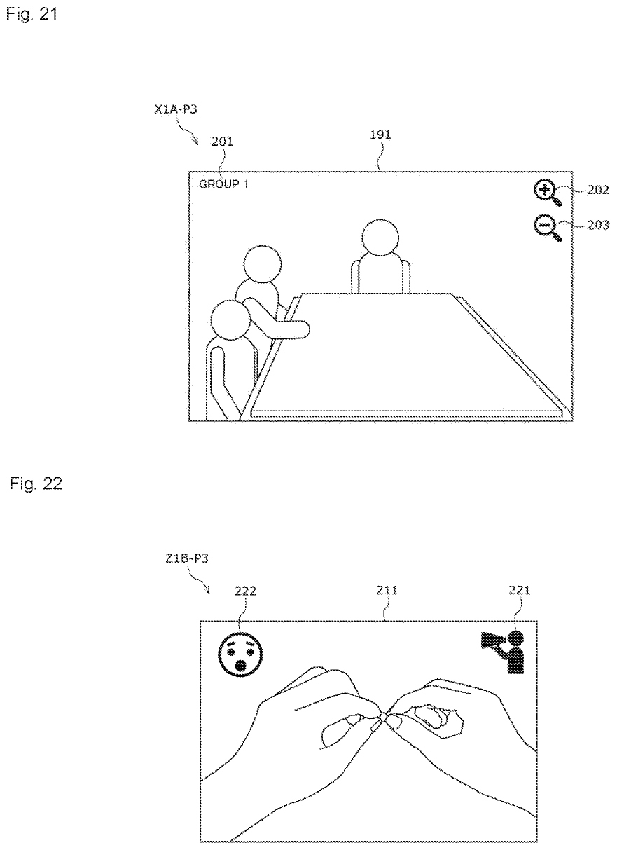

FIG. 21 illustrates an example of an image displayed on the display Y1A-P3 of the information processing device Y1A for teacher in the group conversation mode.

In FIG. 21, a group image 191 which is a captured image of a conversation party group is displayed on the display Y1A-P3. The group image 191 is an image captured by the web camera ZB-P2 for the conversation party group. The faces (upper bodies) of the students in the conversation party group and their desktops appear in the group image 191.

On the displays Y1A-P3, a group name 201 of the group appearing in the group image 191, that is, the conversation party group is superimposed on the group image 191. In FIG. 21, “GROUP 1” is displayed as the group name 201, and accordingly, the group 1 is the conversation party group appearing in the group image 191.

On the display Y1A-P3, a zoom-in icon 202 and a zoom-out icon 203 are superimposed on the group image 191. Each time the zoom-in icon 202 is clicked, the group image 191 is displayed to be enlarged step by step, and each time the zoom-out icon 203 is clicked, the group image 191 is displayed to be reduced step by step.

In the group conversation mode, icons for group conversation are displayed on the display ZB-P3 of the information processing device ZB for the conversation party group in the space B.

FIG. 22 illustrates an example of icons displayed on a display for a conversation party group in the group conversation mode.

In FIG. 22, the conversation party group is the group 1, and the display for the conversation party group is the display Z1B-P3 for the group 1.

In FIG. 22, on the display Z1B-P3, a speech icon 221 and a stamp icon 222 are superimposed on any image 211. The image 211 is any image such as a material image used for the class, rather than a specific image determined by the group conversation processing.

The speech icon 221 is displayed according to the speech of the teacher T1A. The speech icon 221 is not displayed when the teacher T1A is not speaking. With this speech icon 221, the students U1B in the group 1 can visually as well as aurally determine whether or not the teacher T1A is speaking.

The stamp icon 222 is a stamp selected from an icon list displayed when the teacher T1A clicks the stamp icon 57 in FIG. 10 on the display Y1A-P3 for teacher. As selectable stamps, various types of stamps representing emotions and the like are prepared. The display of the stamp icon 222 makes it possible for the teacher T1A to convey to the students a variety of feelings that are difficult to convey by voice alone.

Information representing speech and emotions may be displayed in a form different from that of the speech icon 221 and the stamp icon 57.

In the group conversation processing, in FIG. 5, the group images 152 to 155 of the groups 1 to 4 captured by the web cameras Z1B-P2 to Z4B-P2 for student from the microphone Y1A-P4 for teacher in the space A are input from the image input units P18 of the information processing devices Z1B to Z4B for student and supplied to the data transmission units P12, respectively. The data transmission units P12 transmit the group images 152 to 155 supplied from the image input units P18 to the information processing device Y1A for teacher in the space A, which is connected in P2P, via the communication units P11, respectively.

The data reception unit P13 of the information processing device Y1A for teacher receives the group images 152 to 155 transmitted from the information processing devices Z1B to Z4B for student via the communication unit P11, and supplies the group images 152 to 155 to the image output unit P19. The image output unit P19 outputs the group images 152 to 155 supplied from the data reception unit P13 as the list image 151 (see FIG. 19) to the display Y1A-P3 for teacher.

In the group conversation processing, in FIG. 5, a group image (group image 191 in FIG. 21) captured by a web camera ZB-P2 for student in the space B is input from the image input unit P18 of the corresponding information processing device ZB for the conversation party group in the space B and supplied to the data transmission units P12. The voice(s) of the student(s) in the conversation party group, which are input from the microphone ZB-P4 for the conversation party group, are input from the sound input unit P16 of the information processing device ZB for the conversation party group and supplied to the data transmission unit P12. The data transmission unit P12 transmits the group image and voice(s) supplied from the image input unit P18 and the sound input unit P16 to the information processing device Y1A for teacher in the space A, which is connected in P2P, via the communication unit P11.

The data reception unit P13 of the information processing device Y1A for teacher in the space A receives the group image and voice(s) transmitted from the information processing device ZB for the conversation party group in the space B via the communication unit P11. The data reception unit P13 supplies the received group image to the image output unit P19 and supplies the received voice(s) to the sound output unit P17. The image output unit P19 outputs the group image supplied from the data reception unit P13 to the display Y1A-P3 for teacher. The sound output unit P17 outputs the voice(s) of the student(s) in the conversation party group supplied from the data reception unit P13 from the speaker Y1A-P5 for teacher.

In addition, in the group conversation process, in FIG. 5, a voice of the teacher input from the microphone Y1A-P4 for teacher in the space A is input from the sound input unit P16 of the information processing device Y1A for teacher and supplied to the data transmission unit P12. The data transmission unit P12 transmits the voice supplied from the sound input unit P16 to the information processing device ZB for the conversation party group in the space B, which is connected in P2P, via the communication unit P11.

The data reception unit P13 of the information processing device ZB for the conversation party group in the space B receives the voice transmitted from the information processing device Y1A for teacher in the space A via the communication unit P11. The data reception unit P13 supplies the received voice to the sound output unit P17. The sound output unit P17 outputs the voice of the teacher supplied from the data reception unit P13 from the speaker ZB-P5 for the conversation party group.

In group conversation with the lecture/meeting system 1, the teacher T1A can have a group conversation with the students U1B to U4B in the groups 1 to 4 on a per-group basis, so that the teacher T1A can give an appropriate advice for each group depending on the situations of the groups 1 to 4. Further, a group image for the conversation party, which is displayed on the display Y1A-P3 for teacher, makes it possible to give an appropriate advice while grasping the situation of the conversation party group. Further, the speech icon 221 displayed on the display ZB-P3 for the conversation party group makes it possible for the students U1B to U4B to easily and reliably recognize whether or not the teacher T1A is speaking in the group conversation. In addition, the stampcon 212 displayed on the display BZ-P3 for the conversation party group makes it possible for the teacher T1A to convey to the students U1B to U4B a variety of feelings that are difficult to convey by voice alone.

In the group conversation mode, an image of the teacher and the like captured by the web camera Y1A-P2 for teacher may be displayed on the display ZB-P3 for the conversation party group.

In Example 5, a group conversation is started from an information processing device Y for teacher when the group conversation icon 61 in the operation screen 41 of FIG. 10 is clicked on the display Y-P3 of the information processing device Y for teacher, and then an information processing device Z for student is specified as a conversation party. Similarly, a group conversation may be started from an information processing device Z for student when the group conversation icon 61 in the operation screen 41 of FIG. 10 is clicked on the display Z-P3 of the information processing device Z for student, and then an information processing device Y for teacher is specified as a conversation party. Further, a group conversation may be performed between some information processing devices P such as some information processing devices Z for student.

(Flow of Croup Conversation Processing)

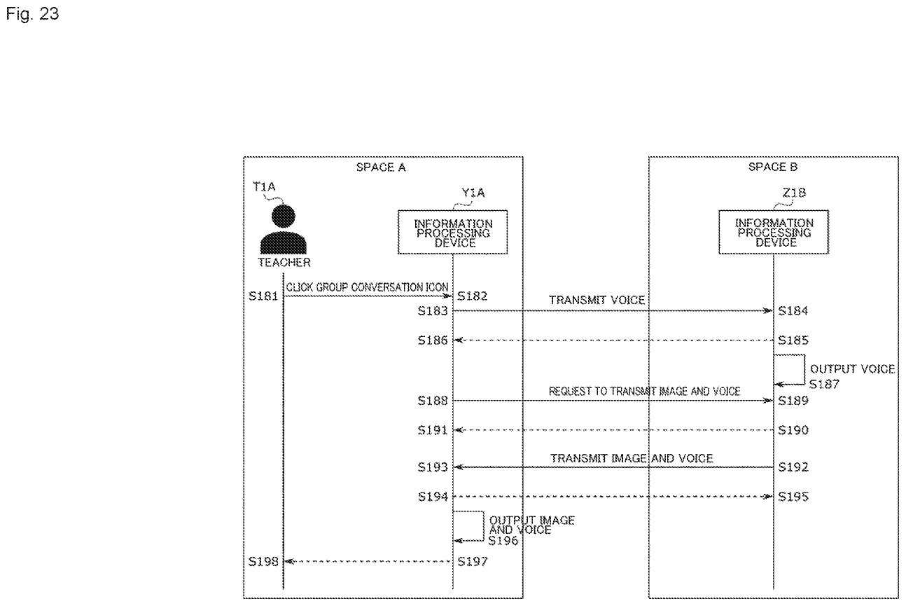

FIG. 23 is a sequence diagram illustrating an example of a flow of group conversation processing in the lecture/meeting system 1.

FIG. 23 illustrates processing for the group 1 specified as a conversation party group by the teacher T1A. For a conversation party group other than the group 1, the processing in the information processing device Z1B for the group 1 in FIG. 23 is similarly performed in the corresponding one of the information processing devices Z2B to Z4B for the conversation party group. In FIG. 23, the processing related to the display of the speech icon 221 and the stamp icon 222 (see FIG. 22) is omitted. In step S181, the teacher T1A clicks the group conversation icon 61 (see FIG. 10) in the operation screen 41 on the display Y1A-P3 (see FIG. 8) of the information processing device Y1A for teacher in the space A. It is assumed that the teacher T1A has specified the group 1 as a conversation party of a group conversation. The processing proceeds from step S181 to step S182.

In step S182, the information processing device Y1A receives the operation in step S181. The processing proceeds from step S182 to step S183.

In step S183, the information processing device Y1A transmits a voice of the teacher, which has been input from its own microphone Y1A-P4, to the information processing device Z1B for the group 1 as the conversation party in the space B (see FIG. 9). The processing proceeds from step S183 to step S184.

In step S184, the information processing device Z1B receives the voice transmitted from the information processing device Y1A in step S183. The processing proceeds from step S184 to step S185.

In step S185, the information processing device Z1B transmits to the information processing device Y1A a response indicating that the voice has been received from the information processing device Y1A in step S184. The processing proceeds from step S185 to step S186.

In step S186, the information processing device Y1A receives the response transmitted from the information processing device Z1B in step S185. After that, voices are continuously transmitted from the information processing device Y1A to the information processing device Z1A. The processing proceeds from step S186 to step S187.

In step S187, the information processing device Y1A outputs the voice of the teacher transmitted from the information processing device Y1A from its own speaker Y1A-P5. The processing proceeds from step S187 to step S188.

In step S188, the information processing device Y1A transmits a request to transmit a group image and voice(s) to the information processing device Z1B. The processing proceeds from step S188 to step S189.

In step S189, the information processing device Z1B receives the request transmitted from the information processing device Y1A in step S183. The processing proceeds from step S189 to step S190.

In step S190, the information processing device Z1B transmits a response to the request received in step S189 to the information processing device Y1A. The processing proceeds from step S190 to step S191.

In step S191, the information processing device Y1A receives the response transmitted from the information processing device Z1B in step S190. The processing proceeds from step S191 to step S192.

In step S192, the information processing device Z1B transmits to the information processing device Y1A a group image of the group 1 captured by its own web camera Z1B-P2 (see FIG. 9) and a voice(s) of the group 1 input from its own microphone Z1B-P4. The processing proceeds from step S192 to step S193.

In step S193, the information processing device Y1A receives the group image and voice(s) transmitted from the information processing device Z1B in step S192. The processing proceeds from step S193 to step S194.

In step S194, the information processing device Y1A transmits to the information processing device Z1B a response indicating that the group image and voice(s) have been received from the information processing device Z1B. The processing proceeds from step S194 to step S195.

In step S195, the information processing device Z1B receives the response transmitted from the information processing device Y1A in step S194. After that, group images and voices are continuously transmitted from the information processing device Z1B to the information processing device Y1A. The processing proceeds from step S195 to step S196.

In step S196, the information processing device Y1A outputs the group image transmitted from the information processing device Z1B to its own display Y1A-P3. The information processing device Y1A outputs the voice(s) transmitted from the information processing device Z1B from its own speaker Y1A-P5. As a result, the group image 191 of the group 1 as illustrated in FIG. 21 is displayed on the display Y1A-P3. The processing proceeds from step S196 to step S197.

In step S197, the information processing device Y1A displays on the display Y1A-P3 a notification indicating that transmission of the group image and voice(s) in the group conversation has been properly started. The processing proceeds from step S197 to step S198.

In step S198, the teacher T1A confirms the content displayed in step S197.

According to Examples 1 to 5 of the lecture/meeting system 1 described above, eve when the lecture view, overhead view, group view, and group conversation processing (functions) make it possible for a teacher to give a class to students in other spaces, it is possible to understand the situations such as the degree of interest and progress of the students in real time. In particular, the overhead view makes it easier for the teacher to sense the atmosphere in the entire space. As a result, the teacher can flexibly change the arrangement and content of a program and proceed with the class while controlling the situations. In addition, the teacher can have an individual conversation with a student(s) (group) as appropriate, so that the teacher can answer a students' question and give an advice to help the student with progress and proceed with the class while controlling the situations at any time.

PTL 1 (JP 2014-153688A) discloses a technology in which a lecturer and students exchange information with each other, and information provided from a student is shared by the teacher and other students.

However, with the technology of PTL 1, it is not easy for the teacher to sense the atmosphere in the entire space as in the present technology, and thus it is difficult to change the arrangement and content of a class flexibly according to the degree of interest and progress of the students and to proceed with the class while controlling the atmosphere.

### Example 6: Space Travel Processing Example

(Start of Space Travel)

An example of space travel processing will be described that is performed when a class associated with Scenario 5 is being given in the configuration of the lecture/meeting system 1 in FIG. 4, the configuration of the information processing system 11A in the space A in FIG. 8, and the configuration of the information processing system 11B in the space B in FIG. 9.

If the teacher T1A wishes to virtually travel in the space B to know about the situations of the groups 1 to 4, for example, the teacher T1A clicks the space travel icon 56 in the operation screen 41 of FIG. 10, which is displayed on the display Y1A-P3 (see FIG. 8) of the information processing device Y1A for teacher. When the space travel icon 56 is clicked, space travel processing is performed and the lecture/meeting system 1 is set to a space travel mode.

In the space travel mode, a space map 241 is displayed on the display Y1A-P3 (see FIG. 8) of the information processing device Y1A for teacher in the space A. The space map 241 is superimposed on the image displayed on the display Y1A-P3 before the display of the space map 241 is started.

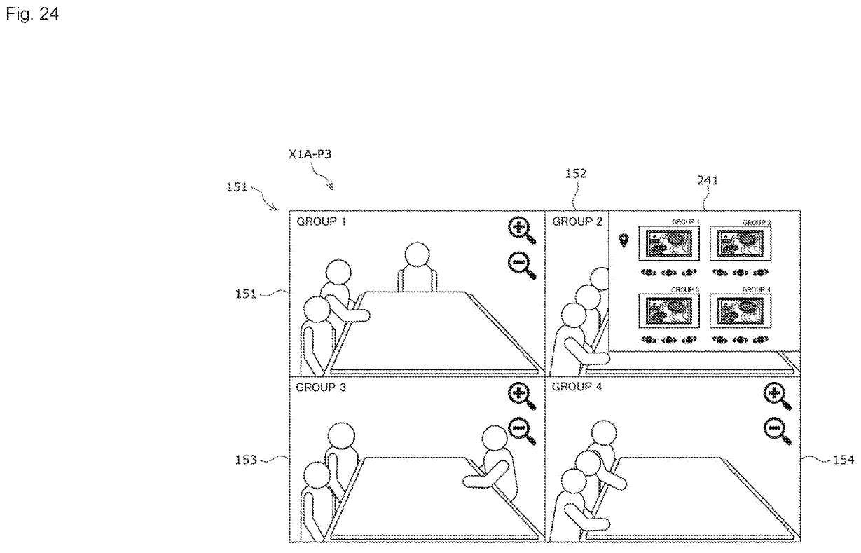

FIG. 24 illustrates an example of images displayed on the display Y1A-P3 of the information processing device Y1A for teacher in a space travel mode.

In FIG. 24, on the display X1A-P3, a space map 241 is superimposed on the list image 151 of the group images 152 to 155 for the group view mode of FIG. 19. The image behind the space map 241 is not limited to the list image 151 for the group view mode, and is any image on which the processing for displaying on the display X1A-P3 is performed when the space travel icon 56 is clicked. That processing of displaying on the display X1A-P3 may be continued even in the space travel mode, or at the same time when the space travel processing is started, the group view processing may be also started to display the list image 151 as illustrated in FIG. 24.

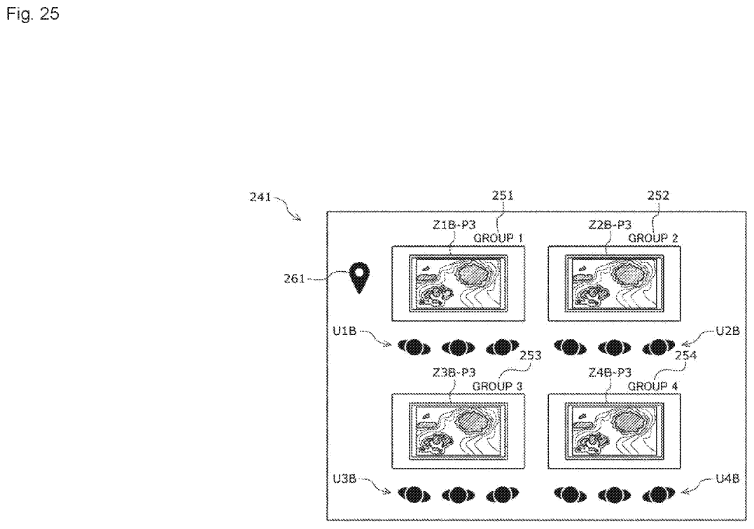

FIG. 25 illustrates an example of the space map 241 in an initial state.

In FIG. 25, in the space map 241, schematic diagrams illustrating the displays ZB-P3 (Z1B-P3 to Z4B-P3) of the information processing devices ZB for student (for group) used by the students U1B to U4B in the groups 1 to 4 in the space B are rendered at positions corresponding to the arrangement of the displays ZB-P3 in the space B. The position of each display ZB-P3 for group in the space map 241 represents the position of the desk used by the students in the corresponding group.

In the space map 241, schematic diagrams of the students U1B to U4B in the groups 1 to 4 are rendered at positions corresponding to the positions of the students U1B to U4B in the space B.

In the space map 241, a current position icon 261 representing a virtual position (current position) of the teacher T1A in the space B is rendered. The current position icon 261 is rendered at a predetermined initial position at the start of display of the space map 241 on the display Z1B-P3.

In the space travel mode, the space map 241 of FIG. 25 is displayed on each display ZB-P3 for group in the space B in the same manner as with the display Y1A-P3 for teacher. The space map 241 is superimposed on the image displayed on each display ZB-P3 before the display of the space map 241 is started.

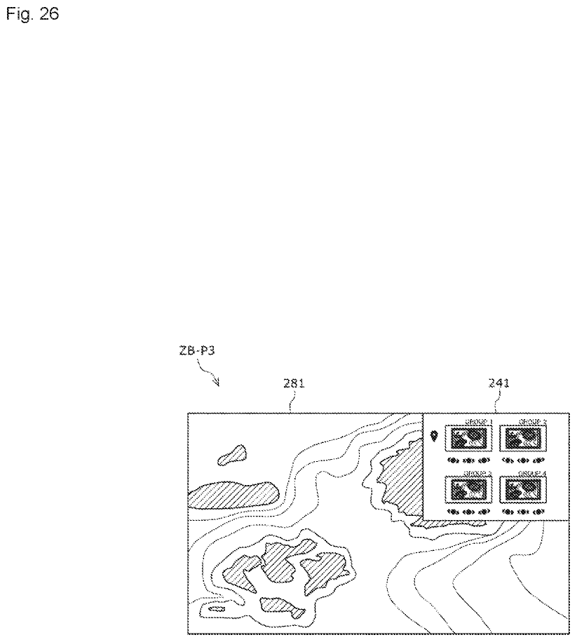

FIG. 26 illustrates an example of an image displayed on the display ZB-P3 of each information processing device ZB for group in the space travel mode.

In FIG. 26, on each display ZB-P3 for group, the space map 241 of FIG. 25 is superimposed on, for example, a material image 281. The background image of the space map 241 is not limited to the material image 281, and is any image on which the processing for displaying on the display ZB-P3 is performed when the space travel icon 56 is clicked. That processing for displaying on the display ZB-P3 is continued even in the space travel mode.

In the processing of creating the space map 241, in FIG. 5, the overhead image captured by the video camera of the composite sensor X1B-P6 in the space B is supplied from the image input unit P18 of the general information processing device X1B in the space B to the space map creation unit P20. In addition, sensing data detected by various types of sensors (such as a video camera, a depth sensor, a spatial microphone array, and an orientation sensor) of the composite sensor X1B-P6 is acquired by the person position detection unit P21 of the general information processing device X1B. The person position detection unit P21 analyzes the positions in the space B of the students U1B to U4B in the groups 1 to 4 in the space B based on the sensing data of the various types of sensors, and supplies the analysis result to the space map creation unit P20.

The space map creation unit P20 detects the positions of the students U1B to U4B, the positions of the desks of the groups 1 to 4 in the space B, and the like based on the overhead view image supplied from the image input unit P18 and the analysis result supplied from the person position detection unit P21, and creates the space map 241 as illustrated in FIG. 25 based on the detection results. The space map creation unit P20 supplies the created space map 241 to the data transmission unit P12. The space map 241 supplied to the data transmission unit P12 is transmitted to the information processing device Y1A for teacher in the space A and each information processing device ZB for group in the space B via the communication unit P11.

The data reception units P13 of the information processing device Y1A for teacher and each information processing device Z for group receive the space map 241 from the general information processing device X1B and supplies the space map 241 to the output unit P15. The output unit P15 of the information processing device Y1A for teacher outputs the supplied space map 241 to the display Y1A-P3. Similarly, the output unit P15 of each information processing device ZB for group outputs the supplied space map 241 to the display ZB-P3.

(Space Movement)

In the space travel mode, the teacher T1A can perform a drag operation on the current position icon 261 in the space map 241 in FIG. 25 displayed in the display Y1A-P3 for teacher as illustrated in FIG. 24 to move virtually in the space B (travel in the space). The drag operation on the space map 241 by the teacher T1A is an operation for space movement indicating virtual movement of the teacher T1A in the space B, and is not limited to a specific operation method.

When the teacher T1A moves virtually in the space B, the rendering of the space map 241 displayed on the display Y1A-P3 for teacher and each display ZB-P3 for group is updated (changed).

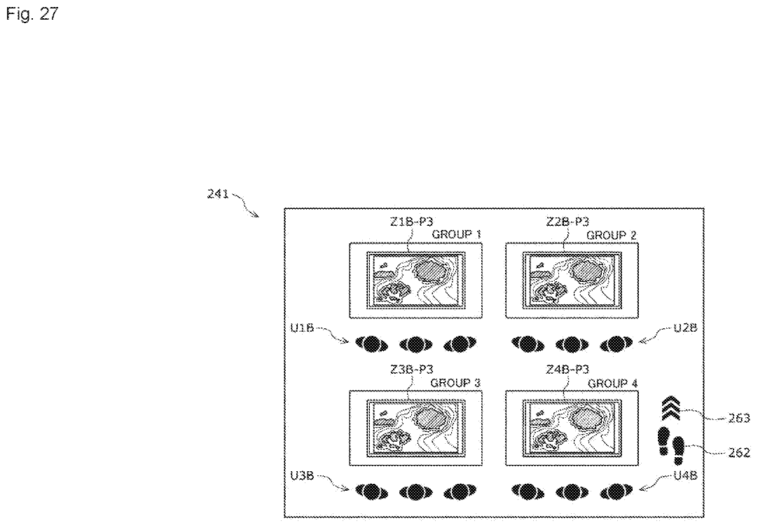

FIG. 27 illustrates a rendering example of the space map 241 when the teacher T1A is virtually moving in the space B.

In FIG. 27, a footprint icon 262 and a movement direction icon 263 are rendered in the space map 241 instead of the current position icon 261 (see FIG. 25).

The footprint icon 262 indicates the current position in the space B of the teacher T1A who is moving virtually in the space B. The footprint icon 262 moves to a position corresponding to a drag operation on the space map 241 by the teacher T1A, and the virtual current position of the teacher T1A in the space B changes to the position corresponding to the footprint icon 262 in the space map 241.

The movement direction icon 263 indicates the movement direction of the teacher T1A who is virtually moving in the space B. The movement direction indicated by the movement direction icon 263 changes according to the direction of the drag operation by the teacher T1A. When the teacher T1A's drag operation stops and accordingly, the teacher T1A's virtual movement in the space B stops, the movement direction icon 263 disappears. When the teacher T1A stops and does not do any specific action for a certain period of time, the footprint icon 262 indicating the current position is changed to the current position icon 261 (see FIG. 25).

In the space travel mode, the footsteps of the teacher T1A who is virtually moving in the space B are output from each speaker ZB-P5 for group. The footsteps from each speaker ZB-P5 are generated when the distance between the virtual position of the teacher T1A in the space B and each of the groups 1 to 4 reaches a predetermined distance or less. The distance between the teacher T1A and each group is, for example, the shortest distance between the teacher T1A and each desk used by the groups.

When the virtual position of the teacher T1A in the space B becomes closer to the group 1 within the predetermined distance, footsteps are output from the speaker P5 of the information processing device Z1B. Then, when the teacher T1A leaves the group 1 and becomes closer to the group 2 within the predetermined distance, the footsteps from the speaker Z1B-P5 of the information processing device Z1B disappear, and footsteps are output from the speaker Z2B-P6 of the information processing device Z2B.

The volume of the footsteps from each speaker ZB-P5 for group may be changed according to the distance between the virtual position of the teacher T1A in the space B and the corresponding group. For example, the closer to a certain group the teacher T1A is, the higher the volume of the footsteps output from the speaker ZB-P5 for that group.

A notification unit for notifying that the teacher T1A is virtually close to one of the groups in the space B may be used such as a rotating light, a projector, or the like. For a method using a rotating light, for example, a rotating light is installed on the desk or the like for each group. When the virtual position of the teacher T1A in the space B is close to a predetermined group within the predetermined distance, the rotating lamp for the predetermined group is turned on. In addition, the closer to the predetermined group the teacher T1A is, the faster the rotation speed of the revolving lamp. For a method using a projector, for example, a footprint image is projected at the actual position in the space B corresponding to the virtual position of the teacher T1A in the space B.

Such footsteps of the teacher T1A can give the students feelings of nervousness due to being monitored by the teacher.

In the processing of updating the space map 241, in FIG. 5, the arrangement of the desks and students in the groups in the space map 241 is detected by the space map creation unit P20 and the person position detection unit P21 in the same manner as the above-described processing of creating the space map 241.

The person position detection unit P21 of the information processing device Y1A for teacher acquires the image captured by the video camera of the composite sensor Y1A-P6 for teacher and the sensing data detected by the depth sensor. The composite sensor Y1A-P6 for teacher is installed at a position where the hand of the teacher T1A is within the sensing range, for example.

The person position detection unit P21 of the information processing device Y1A detects the movement of the hand of the teacher T1A based on the sensing data of the video camera and the depth sensor acquired from the composite sensors Y1A-P6. The person position detection unit P21 detects from the detected movement of the hand of the teacher T1A the operation direction and operation amount of a drag operation on the current position icon 261 (see FIG. 25) in the space map 241 on the display Y1A-P3 for teacher. The person position detection unit P21 detects the virtual space movement direction and movement distance of the teacher T1A in the space B based on the detected operation direction and operation amount of the drag operation.

The operation direction and operation amount of the drag operation by the teacher T1A may be detected by the touch panel of the display Y1A-P3, and are not limited to a specific detection method.

The space movement direction and movement distance of the teacher T1A detected by the person position detection unit P21 of the information processing device Y1A are transmitted as metadata to the general information processing device X1B in the space B via the communication unit P11. The space map creation unit P20 of the information processing device X1B acquires the metadata transmitted from the information processing device Y1A via the communication unit P11 and the data reception unit P13.

The space map creation unit P20 of the information processing device X1B detects the virtual current position and movement direction of the teacher T1A in the space B based on the acquired metadata. The space map creation unit P20 renders the footprint icon 262 of FIG. 27 at a position in the space map 241 corresponding to the detected virtual current position of the teacher T1A in the space B. The space map creation unit P20 renders in the space map 241 the movement direction icon 242 of FIG. 27 which indicates a movement direction in the space map 241 corresponding to the detected virtual space movement direction of the teacher T1A.

The space map creation unit P20 of the information processing device X1B creates the space map 241 as illustrated in FIG. 27 in which the position of the footprint icon 262 and the like is updated, and supplies the updated space map 241 to the data transmission unit P12. The space map 241 supplied to the data transmission unit P12 is transmitted to the information processing device Y1A for teacher in the space A and each information processing device ZB for group in the space B via the communication unit P11, and the space maps 241 which are displayed on the display Y1A-P3 for teacher and each display ZB-P3 for group are updated.

The space map creation unit P20 of the information processing device X1B calculates a distance between the virtual current position of the teacher T1A in the space B and each group and supplies the distance to the processing unit P22. Based on the distance from the space map creation unit P20, the processing unit P22 detects a group to which the distance from the virtual current position of the teacher T1A in the space B is shorter (smaller) than a predetermined distance. As a result of the detection, the processing unit P22 transmits a footstep output request to the information processing device ZB for the group to which the distance from the virtual current position of the teacher T1A in the space B is shorter than the predetermined distance, via the communication unit P11. The processing unit P22 of the information processing device ZB, which has received the footstep output request from the information processing device X1B via the communication unit P11 and the data reception unit P13, causes the sound output unit P17 to output footsteps from its own speaker ZB-P5.

During the space travel, a virtual space movement of the teacher T1A in the space B is not performed based on a drag operation by the teacher T1A, but a space movement may be automatically performed according to an automatically determined route. In this case, for example, the space map creation unit P20 of the information processing device X1B automatically determines a travel route so as to pass through positions near the groups 1 to 4 at regular intervals, and moves the teacher T1A automatically and virtually.

According to the space travel in the lecture/meeting system 1, even if a teacher is present in a different space from a space in which students are present, the teacher can travel in the space in which the students are present as if the teacher were present in the same classroom with the students, and understand the overall atmosphere to control the situations. In addition, the teacher can give the students feelings of nervousness due to the space travel.

(Group Conversation)

If the teacher T1A wishes to have a conversation with a predetermined group in the space travel mode, the teacher T1A stops the drag operation on the space map 241 and clicks the group conversation icon 61 in the operation screen 41 of FIG. 10. In this case, the teacher T1A can have a group conversation with the specified conversation party group in the same manner as described in Example 5. The conversation party group may be automatically determined as the group closest to the virtual current position of the teacher T1A in the space B.

In the space travel mode and in the group conversation mode, the group image 191 of FIG. 21, which is a captured image of the conversation party group, is displayed on the display Y1A-P3 for teacher. As illustrated in FIG. 22, the speech icon 221 and the stamp icon 222 are displayed on the display BZ-P3 for the conversation party group.

In the space travel mode and in the group conversation mode, the space map 241 as illustrated in FIGS. 24 and 26 is displayed on the display Y1A-P3 for teacher and each display ZB-P3 for group.

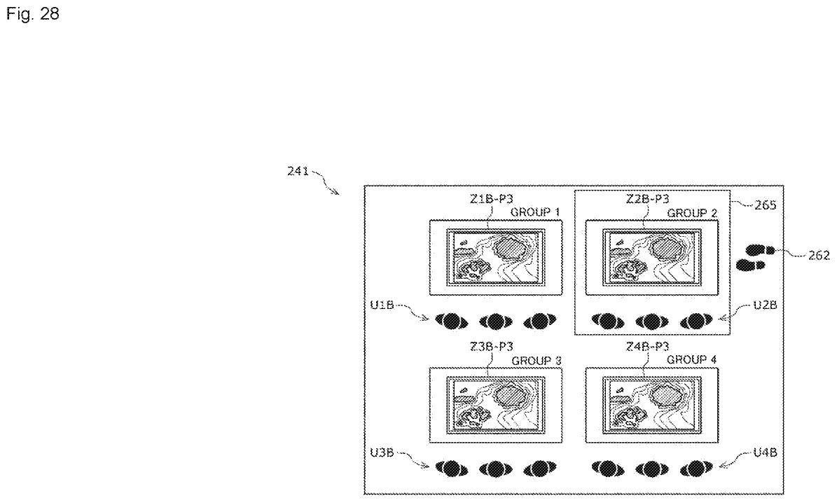

FIG. 28 illustrates a rendering example of the space map 241 when a group conversation is started in the space travel mode.

In FIG. 28, the footprint icon 262 and a conversation party frame 265 are rendered in the space map 241. FIG. 28 illustrates a case where the group 2 is specified as a conversation party group by way of example.

The footprint icon 262 is rendered facing the conversation party group 2. The conversation party frame 265 is a rectangular frame representing the conversation party group. In FIG. 28, the conversation party frame 265 indicates that the conversation party group is the group 2, and is rendered to enclose the display Z2B-P3 for the conversation party group 2 and the students U2B in the group 2.

Regardless of whether or not the group conversation is started, the group image of the group to which the virtual current position of the teacher T1A in the space B is closer within a predetermined distance may be automatically displayed on the display Y1A-P3 for teacher.

During the space travel, the image displayed on the display Y1A-P3 for teacher and the voice output from the speaker Y1A-P5 for teacher may be automatically switched to the image and voice of the group which is closest to the position of the teacher T1A in the space B. This may allow the teacher T1A to freely have an interactive conversation.

(Flow of Space Travel Processing)

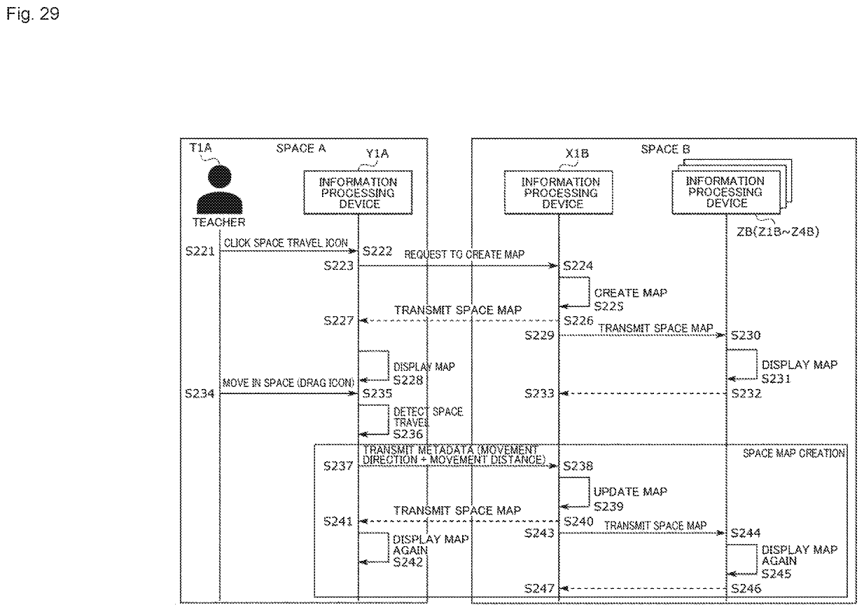

FIG. 29 is a sequence diagram illustrating an example of a flow of space travel processing in the lecture/meeting system 1.

In step S221, the teacher T1A clicks the space travel icon 56 (see FIG. 10) in the operation screen 41 on the display Y1A-P3 (see FIG. 8) of the information processing device Y1A for teacher in the space A. The processing proceeds from step S121 to step S122.

In step S222, the information processing device Y1A receives the operation in step S221. The processing proceeds from step S222 to step S223.

In step S223, the information processing device Y1A transmits a request to create the space map 241 to the general information processing device X1B in the space B (see FIG. 9). The processing proceeds from step S223 to step S224.

In step S224, the information processing device X1B receives the request to create the space map 241 transmitted from the information processing device Y1A in step S223. The processing proceeds from step S224 to step S245.

In step S225, the information processing device X1B creates the space map 241 of the space B. The processing proceeds from step S225 to step S226.

In step S226, the information processing device X1B transmits the space map 241 created in step S225 to the information processing device Y1A. The processing proceeds from step S226 to step S227.

In step S227, the information processing device Y1A receives the space map 241 transmitted from the information processing device X1B in step S226. The processing proceeds from Step S227 to Step S228.

In step S228, the information processing device Y1A outputs the space map 241 received in step S227 to the display Y1A-P3 for teacher. As a result, the space map 241 as illustrated in FIGS. 24 and 25 is displayed on the display Y1A-P3. The processing proceeds from step S228 to step S229.

In step S229, the information processing device X1B transmits the space map 241 created in step S225 to all the information processing devices ZB (Z1B to Z4B) for student in the space B. The processing proceeds from step S229 to step S230.

In step S230, each information processing device ZB receives the space map 241 transmitted from the information processing device X1B in step S229. The processing proceeds from step S230 to step S231.

In step S231, each information processing device ZB outputs the space map 241 received from the information processing device X1B in step S230 to the display ZB-P3. As a result, the space map 241 as illustrated in FIGS. 25 and 26 is displayed on the display P3 of each information processing device ZB. The processing proceeds from step S231 to step S232.

In step S232, each information processing device ZB transmits a response indicating that the space map 241 has been received to the information processing device X1B. The processing proceeds from step S232 to step S233.

In step S233, the information processing device X1B receives the response signal transmitted from the information processing device ZB in step S232.

After that, in steps S234 to S236, the information processing device Y1A repeatedly detects the movement direction and the movement distance according to an operation for the space movement indicating a virtual movement in the space B by the teacher T1A. Then, when the movement distance detected by the information processing device Y1A is not 0, that is, when the teacher T1A performs the drag operation, space map creation processing is performed in steps S237 to S247. The space map creation processing in steps S237 to S247 is processing of creating (updating) the space map 241 to be displayed on the display Y1A-P3 of the information processing device Y1A and the display ZB-P3 of each information processing device ZB based on an operation for the space movement by the teacher T1A.

In step S234, the teacher T1A performs a drag operation on the current position icon 261 (see FIG. 25) in the space map 241. In other words, the teacher T1A performs a drag operation to virtually move in the space B (space movement). The processing proceeds from step S234 to step S235.

In step S235, the information processing device Y1A receives the operation in step S234. The processing proceeds from step S235 to step S236.

In step S236, the movement direction and movement distance of the virtual space movement in the space B corresponding to the operation received in step S235 are detected. The processing proceeds from step S236 to step S237.

As described above, the processing of creating a space map is performed in steps S237 to S247 described below.

In step S237, the information processing device Y1A transmits metadata indicating the movement direction and movement distance detected in step S236 to the information processing device X1B. The processing proceeds to step S238.

In step S238, the information processing device X1B receives the metadata transmitted from the information processing device Y1A in step S237. The processing proceeds from step S238 to step S239.

In step S239, the information processing device X1B updates the space map 241 of the space B based on the metadata received in step S237. The processing proceeds from step S239 to step S240.

In step S240, the information processing device X1B transmits the space map 241 created (updated) in step S239 to the information processing device Y1A. The processing proceeds from step S240 to step S241.

In step S241, the information processing device Y1A receives the space map 241 transmitted from the information processing device X1B in step S240. The processing proceeds from step S241 to step S242.

In step S242, the information processing device Y1A outputs the space map 241 received in step S241 to the display Y1A-P3. As a result, the space map 241 as illustrated in FIG. 27 is displayed again on the display Y1A-P3. The processing proceeds from step S242 to step S243.

In step S243, the information processing device X1B transmits the space map 241 created (updated) in step S239 to all the information processing devices ZB for group in the space B. The processing proceeds from step S243 to step S244.

In step S244, each information processing device ZB receives the space map 241 transmitted from the information processing device X1B in step S243. The processing proceeds from step S244 to step S245.

In step S245, each information processing device ZB outputs the space map 241 received from the information processing device X1B in step S244 to the display P3. As a result, the space map 241 as illustrated in FIG. 27 is displayed again on the display P3 of each information processing device ZB. The processing proceeds from step S245 to step S246.

In step S246, each information processing device ZB transmits a response indicating that the space map 241 has been received to the information processing device X1B. The processing proceeds from step S246 to step S247.

In step S247, the information processing device X1B receives the response signal transmitted from the information processing device ZB in step S246.

(Flow of Processing of Footsteps and Others During Space Travel)

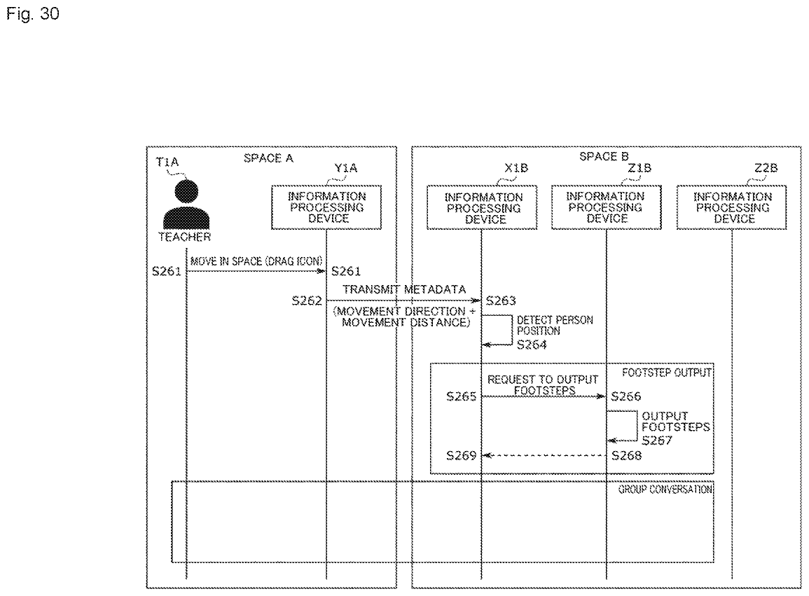

FIG. 30 is a sequence diagram illustrating an example of a flow of processing of footsteps and others in the space travel mode in the lecture/meeting system 1. FIG. 30 illustrates processing after the processing of steps S221 to S233 in FIG. 29 has been performed.

In step S261, the teacher T1A performs a drag operation on the current position icon 261 (see FIG. 25) in the space map 241. In other words, the teacher T1A performs an operation to virtually move in the space B (space movement).

Steps S261 to S263 correspond to the processing of steps S234 to S238 in FIG. 29, and accordingly, the description thereof will be omitted. In FIG. 30, the illustration of processing corresponding to step S236 in FIG. 29 is also omitted.

In step S264, the general information processing device X1B (see FIG. 9) A in the space B detects the virtual position of the teacher T1A in the space B based on the metadata indicating the movement direction and movement distance received from the information processing device Y1A in step S263. At that time, it is assumed that the detected position of the teacher T1A is close to the position of the group 1 in the space B within a predetermined distance. It is also assumed that the detected position of the teacher T1A is at a distance more than the predetermined distance from the positions of the groups 2 to 4. The processing proceeds from step S264 to step S265.

In step S265, the information processing device X1B transmits a footstep output request to the information processing device Z1B used by the students U1A in the group 1 from which the position of the teacher T1A in the space B detected in step S264 has a distance equal to or less than the predetermined distance. The processing proceeds from step S265 to step S266. The information processing device X1B does not transmit a footstep output request to the information processing devices Z2B to Z4B (only the information processing device Z2B is illustrated in FIG. 30) used by the students U2B to U4B in the groups 2 to 4 from which the position of the teacher T1A in the space B detected in step S264 has a distance more than the predetermined distance.

In step S266, the information processing device Z1B receives the footstep output request transmitted from the information processing device X1B in step S265. The processing proceeds from step S266 to step S267.

In step S267, the information processing device Z1B outputs footsteps from its own speaker P5. The processing proceeds from step S267 to step S268.

In step S268, the information processing device Z1B transmits a response indicating that the sound output request has been received to the information processing device X1B. The processing proceeds from step S268 to step S269.

In step S269, the information processing device X1B receives the response transmitted from the information processing device Z1B in step S268.

After that, when the virtual position of the teacher T1A in the space B leaves the group 1 and moves close to any one of the other groups 2 to 4 at a position within the predetermined distance, the processing of steps S265 to S267 is performed between the information processing device ZB used by the students in that group and the information processing device X1B.

Further, in the state after step S269 in which the teacher T1A is close to the group 1 in the space B at a position within the predetermined distance, now assume that the group conversation icon 61 (see FIG. 10) in the operation screen 41 on the display Y1A-P3 (see FIG. 8) of the information processing device Y1A for teacher in the space A is clicked.

In this case, for the group 1 as the conversation party, the processing of steps S181 to S198 illustrated in FIG. 23 is performed between the information processing device Y1A and the information processing device Z1B. The group conversation processing is the same as in FIG. 23, and accordingly, the illustration in FIG. 30 and description thereof will be omitted.

### Example 7: Teacher Call Processing Example

An example of teacher call processing will be described that is performed when a class associated with Scenario 5 is being given in the configuration of the lecture/meeting system 1 in FIG. 4, the configuration of the information processing system 11A in the space A in FIG. 8, and the configuration of the information processing system 11B in the space B in FIG. 9.

In the space travel mode of Example 6, when the teacher T1A moves virtually close to a predetermined group in the space B, the students in that group click the call icon 60 in the operation screen 41 of FIG. 10 displayed on the display ZB-P3 for its own group, for example, to have a conversation with the teacher T1A. When the call icon 60 is clicked, teacher call processing is performed.

When the teacher call processing is performed, a teacher call icon (including text information) is displayed on the display P3 of the information processing device ZB on which the call icon 60 is clicked.

FIG. 31 illustrates an example of an image displayed on the display P3 of the information processing device ZB for the group which called the teacher in the space travel mode. FIG. 31 illustrates a case where the group 4 is the group which called the teacher. The teacher call can be performed by any group at any timing, and the teacher can call any group.

In FIG. 31, on the display Z4B-P3 for the group 4 that called the teacher, a teacher call icon 311 as well as the space map 241 is superimposed on, for example, the material image 281 in the space travel mode of FIG. 26.

The teacher call icon 311 is an icon to notify the student(s) that the teacher is being called. The teacher call icon 311 includes a picture representing a bell and text information “Calling the teacher . . . ”

When the teacher call processing is performed, a teacher call icon is also displayed on the display Y1A-P3 for teacher (see FIG. 8).

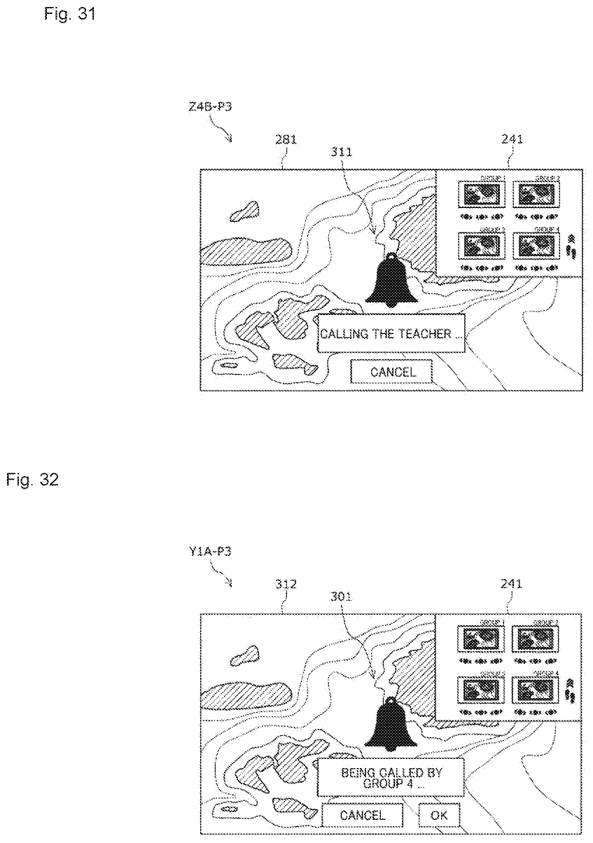

FIG. 32 illustrates an example of an image displayed on the display Y1A-P3 of the information processing device Y1A for teacher in the space travel mode.

In FIG. 32, on the display Y1A-P3, a teacher call icon 312 as well as the space map 241 is superimposed on any image 301 displayed on the display Y1A-P3 at the time when the space travel icon 56 is clicked.

The teacher call icon 312 is an icon to notify the student that the student(s) are calling. The teacher call icon 312 includes a picture representing a bell and text information “Being called by Group 4” The text information clearly indicates which group is calling.

When the teacher call processing is performed, a ringing tone (for example, a bell sound) is output from the speaker P5 of the information processing device Y1A for teacher.

The teacher T1A is informed of a call and which group is calling through the display of the teacher call icon 312 and the ringing tone. For example, by clicking the teacher call icon 312 or by clicking the group conversation icon 61 in the operation screen 41 of FIG. 10 which is displayed on the display Y1A-P3, the teacher T1A can start a group conversation with the called group.

In the teacher call processing, in FIG. 5, when the processing unit P22 of the information processing device ZB for the group that calls the teacher receives a notification of the click operation on the call icon 60 of FIG. 10 from the input unit P14, the processing unit P22 instructs the output unit P15 to output the teacher call icon 311 of FIG. 31. In accordance with the instruction, the output unit P15 outputs the teacher call icon 311 on the display ZB-P3 as illustrated in FIG. 31.

The processing unit P22 also transmits a notification of the teacher call to the teacher information processing device Y1A via the communication unit P11.

The processing unit P22 of the information processing device Y1A for teacher receives the notification of the teacher call transmitted from the information processing device ZB for group in the space B via the communication unit P11. When receiving the notification, the processing unit P22 instructs the output unit P15 to output the teacher call icon 312 of FIG. 32. In accordance with the instruction, the output unit P15 outputs the teacher call icon 312 on the display Y1A-P3 as illustrated in FIG. 32.

The processing unit P22 also instructs the sound output unit P17 to output a ringing tone. In accordance with the instruction, the sound output unit P17 outputs a ringing tone from its own speaker ZB-P5.

According to the teacher call of the lecture/meeting system 1, the students can proactively ask questions to the teacher T1A, so that the students can actively participate in the class.

In Examples 1 to 7 described above, the cases where the lecture/meeting system 1 is used in Scenario 5 of FIG. 7. However, the lecture/meeting system 1 can be applied to scenarios other than Scenario 5, that is, Scenarios 1 to 4. In that case, the information processing device Y for teacher in Examples 1 to 7 is used as an information processing device for prep school lecturer (for Scenario 1), for professor (for Scenario 2), or for facilitator (for Scenarios 3 and 4), and is disposed in the space A or the space B. Further, the information processing devices Z for student in Examples 1 to 7 are disposed in the space A or the space B as being for trainee (for Scenarios 1, 2, and 3) or for team member (for Scenario 4). The general information processing device X in Examples 1 to 7 is disposed as a general information processing device X in Scenarios 1 to 4 as well.

<Program>

The above-described series of processing performed by any information processing device of the information processing systems 11A, 11B, 11C, . . . and the cloud service 12, which are illustrated in FIG. 1, can also be implemented by hardware and/or software. In a case where the series of processing is performed by software, a program including the software is installed in a computer. Here, the computer includes a computer embedded in dedicated hardware or, for example, a general-purpose personal computer capable of executing various functions by installing various programs.

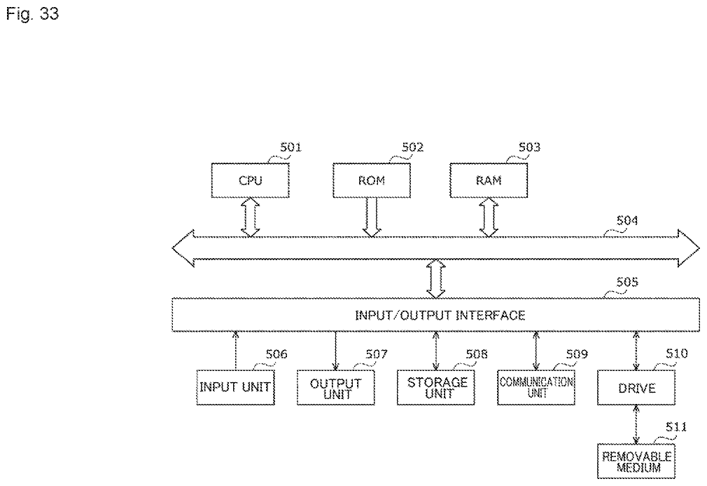

FIG. 33 is a block diagram illustrating an example of a hardware configuration of a computer that executes the above-described series of processing according to a program.

In the computer, a central processing unit (CPU) 501, a read only memory (ROM) 502, and a random access memory (RAM) 503 are connected to each other by a bus 504.

An input/output interface 505 is further connected to the bus 504. An input unit 506, an output unit 507, a storage unit 508, a communication unit 509, and a drive 510 are connected to the input/output interface 505.

The input unit 506 is a keyboard, a mouse, a microphone, or the like. The output unit 507 is a display, a speaker, or the like. The storage unit 508 is a hard disk, non-volatile memory, or the like. The communication unit 509 is a network interface or the like. The drive 510 drives a removable medium 511 such as a magnetic disk, an optical disc, a magneto-optical disk, or a semiconductor memory.

In the computer that has the above configuration, for example, the CPU 501 performs the above-described series of processes by loading a program stored in the storage unit 508 to the RAM 503 via the input/output interface 505 and the bus 504 and executing the program.

The program executed by the computer (the CPU 501) can be recorded on, for example, the removable medium 511 serving as a package medium for supply. The program can be supplied via a wired or wireless transfer medium such as a local area network, the Internet, or digital satellite broadcasting.

In the computer, by mounting the removable medium 511 on the drive 510, it is possible to install the program in the storage unit 508 via the input/output interface 505. The program can be received by the communication unit 509 via a wired or wireless transfer medium to be installed in the storage unit 508. In addition, this program may be installed in advance in the ROM 502 or the storage unit 508.

Note that the program executed by a computer may be a program that performs processing chronologically in the order described in the present specification or may be a program that performs processing in parallel or at a necessary timing such as a called time.

The present technology can be configured as follows.

(1)

An information processing device, including an input unit that receives

an operation for displaying an overhead view image of a second space different from a first space in which the information processing device is disposed on a display unit disposed in the first space;

an operation for displaying a list of a plurality of images of the second space to be captured at a plurality of captured positions on a display unit disposed in the first space;

an operation for displaying an image in the first space on a display unit disposed in the second space;

an operation for outputting a sound in the second space from a sound output unit disposed in the first space; and

an operation for outputting, from a sound output unit disposed in the second space, a sound input from a sound input unit disposed in the first space.

(2)

The information processing device according to (1), wherein the input unit further receives

an operation for making a person who is present at a specific position in the first space have a conversation with a person who is present at one of the plurality of captured positions in the second space and who is a conversation party;

an operation for outputting, from a sound output unit disposed at a position corresponding to the captured position where the conversation party person is present, a sound input from a sound input unit disposed at a position corresponding to the specific position in the first space; and

an operation for outputting, from a sound output unit disposed at a position corresponding to the specific position in the first space, a sound input from a sound input unit disposed at a position corresponding to the captured position where the conversation party person is present.

(3)

The information processing device according to (2), wherein the input unit further receives

an operation for displaying information representing emotions on a display unit disposed at a position corresponding to the captured position where the conversation party person is present.

(4)

The information processing device according to (2) or (3), wherein

on a display unit disposed at a position corresponding to the specific position in the first space, information is displayed indicating a request for a conversation input from an input unit disposed at a position corresponding to each of the plurality of the captured positions in the second space.

(5)

The information processing device according to any one of (1) to (4), wherein the input unit further receives

an operation for displaying, on a display unit disposed at a position corresponding to each of the plurality of the captured positions in the second space, a space map representing a virtual position of the specific person in the second space when the specific person who is present in the first space virtually travels in the second space.

(6)

The information processing device according to (5), wherein the input unit further receives

an operation for displaying the space map on a display unit disposed in the first space.

(7)

The information processing device according to (5) or (6), wherein the input unit further receives

an operation for moving the virtual position of the specific person in the second space.

(8)

The information processing device according to any one of (5) to (7), wherein the virtual position of the specific person in the second space represented by the space map is moved.

(9)

The information processing device according to (7) or (8), wherein a notification unit disposed at a position corresponding to the captured position in the second space makes a notification indicating that the specific person is close to here, the position having a distance equal to or less than a predetermined distance from the virtual position of the specific person in the second space.

(10)

The information processing device according to any one of (7) to (9), wherein the notification unit disposed at a position corresponding to each of the captured positions outputs a sound with a volume corresponding to a distance between the virtual position of the specific person in the second space and each of the plurality of the captured positions in the second space.

(11)

An information processing device, including a display unit that is disposed in a second space different from a first space in which a specific person is present, the display unit displaying a space map that represents a virtual position of the specific person in the second space when the specific person virtually travels in the second space.

(12)

The information processing device according to (11), including:

an image input unit that captures an image at a captured position corresponding to a position of the display unit; and

a display unit that is disposed in the first space to display the image at the captured position.

(13)

The information processing device according to (11) or (12), including:

a sound input unit that is disposed at a position corresponding to a position of the display unit; and

a sound output unit that is disposed in the first space to output a sound input from the sound input unit.

(14)

The information processing device according to any one of (11) to (13), further including a sound output unit that is disposed at a position corresponding to a position of the display unit to output a voice of the specific person.

(15)

The information processing device according to any one of (11) to (14), wherein a position of the display unit is rendered in the space map.

(16)

The information processing device according to any one of (11) to (15), including a notification unit that makes a notification indicating that a distance between the virtual position of the specific person in the second space and a position corresponding to the display unit disposed in the second space is equal to or less than a predetermined distance.

(17)

An information processing method,

including receiving,

by an input unit

included in an information processing device,

an operation for displaying an overhead view image of a second space different from a first space in which the information processing device is disposed on a display unit disposed in the first space;

an operation for displaying a list of a plurality of images of the second space to be captured at a plurality of captured positions on a display unit disposed in the first space;

an operation for displaying an image in the first space on a display unit disposed in the second space;

an operation for outputting a sound in the second space from a sound output unit disposed in the first space; and

an operation for outputting a sound input from a sound input unit disposed in the first space from a sound output unit disposed in the second space.

### REFERENCE SIGNS LIST

1 Lecture/meeting system
11 Information processing system
12 Cloud service
13 Network
21 Communication unit
22 Data transmission unit
23 Data reception unit
24 Device registration unit
25 Matching unit
26 Processing unit
27 Data storage unit
P, X, Y, Z Information processing device
P1 PC main body
P2 Web camera
P3 Display
P4 Microphone
P5 Speaker
P6 Composite sensor

1. An information processing device, comprising an input unit that receives:
an operation for displaying an overhead view image of a second space different from a first space in which the information processing device is disposed on a display unit disposed in the first space;
an operation for displaying a list of a plurality of images of the second space to be captured at a plurality of captured positions on a display unit disposed in the first space;
an operation for displaying an image in the first space on a display unit disposed in the second space;
an operation for outputting a sound in the second space from a sound output unit disposed in the first space; and
an operation for outputting, from a sound output unit disposed in the second space, a sound input from a sound input unit disposed in the first space.

2. The information processing device according to claim 1, wherein the input unit further receives
an operation for making a person who is present at a specific position in the first space have a conversation with a person who is present at one of the plurality of captured positions in the second space and who is a conversation party;
an operation for outputting, from a sound output unit disposed at a position corresponding to the captured position where the conversation party person is present, a sound input from a sound input unit disposed at a position corresponding to the specific position in the first space; and
an operation for outputting, from a sound output unit disposed at a position corresponding to the specific position in the first space, a sound input from a sound input unit disposed at a position corresponding to the captured position where the conversation party person is present.

3. The information processing device according to claim 2, wherein the input unit further receives
an operation for displaying information representing emotions on a display unit disposed at a position corresponding to the captured position where the conversation party person is present.

4. The information processing device according to claim 2, wherein
on a display unit disposed at a position corresponding to the specific position in the first space, information is displayed indicating a request for a conversation input from an input unit disposed at a position corresponding to each of the plurality of the captured positions in the second space.

5. The information processing device according to claim 1, wherein the input unit further receives
an operation for displaying, on a display unit disposed at a position corresponding to each of the plurality of the captured positions in the second space, a space map representing a virtual position of the specific person in the second space when the specific person who is present in the first space virtually travels in the second space.

6. The information processing device according to claim 5, wherein the input unit further receives
an operation for displaying the space map on a display unit disposed in the first space.

7. The information processing device according to claim 5, wherein the input unit further receives
an operation for moving the virtual position of the specific person in the second space.

8. The information processing device according to claim 5, wherein the virtual position of the specific person in the second space represented by the space map is moved.

9. The information processing device according to claim 8, wherein a notification unit disposed at a position corresponding to the captured position in the second space makes a notification indicating that the specific person is close to here, the position having a distance equal to or less than a predetermined distance from the virtual position of the specific person in the second space.

10. The information processing device according to claim 8, wherein a sound output unit disposed at a position corresponding to each of the captured positions outputs a sound with a volume corresponding to a distance between the virtual position of the specific person in the second space and each of the plurality of the captured positions in the second space.

11. An information processing device, comprising a display unit that is disposed in a second space different from a first space in which a specific person is present, the display unit displaying a space map that represents a virtual position of the specific person in the second space when the specific person virtually travels in the second space.

12. The information processing device according to claim 11, further comprising:
an image input unit that captures an image at a captured position corresponding to a position of the display unit; and
a display unit that is disposed in the first space to display the image at the captured position.

13. The information processing device according to claim 11, further comprising:
a sound input unit that is disposed at a position corresponding to a position of the display unit; and
a sound output unit that is disposed in the first space to output a sound input from the sound input unit.

14. The information processing device according to claim 11, further comprising a sound output unit that is disposed at a position corresponding to a position of the display unit to output a voice of the specific person.

15. The information processing device according to claim 11, wherein a position of the display unit is rendered in the space map.

16. The information processing device according to claim 11, further comprising a notification unit that makes a notification indicating that a distance between the virtual position of the specific person in the second space and a position corresponding to the display unit disposed in the second space is equal to or less than a predetermined distance.

17. An information processing method,
comprising receiving,
by an input unit
included in an information processing device,
an operation for displaying an overhead view image of a second space different from a first space in which the information processing device is disposed on a display unit disposed in the first space;
an operation for displaying a list of a plurality of images of the second space to be captured at a plurality of captured positions on a display unit disposed in the first space;
an operation for displaying an image in the first space on a display unit disposed in the second space;
an operation for outputting a sound in the second space from a sound output unit disposed in the first space; and
an operation for outputting, from a sound output unit disposed in the second space, a sound input from a sound input unit disposed in the first space.
